(19) United States
(12) Patent Application Publication
(10) Pub. No.: US 2024/0042323 A1
(43) Pub. Date: Feb. 8, 2024

(54) INFORMATION PROCESSING SYSTEM, METHOD FOR PROCESSING INFORMATION, AND NON-TRANSITORY COMPUTER-READABLE INFORMATION STORAGE MEDIUM

(71) Applicant: GREE, Inc., Tokyo (JP)

(72) Inventor: Akihiko SHIRAI, Kanagawa (JP)

(73) Assignee: GREE, Inc., Tokyo (JP)

(21) Appl. No.: 18/216,615

(22) Filed: Jun. 30, 2023

Related U.S. Application Data
(60) Provisional application No. 63/370,118, filed on Aug. 2, 2022.

(30) Foreign Application Priority Data
Dec. 16, 2022 (JP) 2022-200899

(51) Int. Cl. A63F 13/58; G06T 13/40; G06T 19/20; G06T 7/70; A63F 13/798

(52) U.S. Cl. CPC A63F 13/58; G06T 13/40; G06T 19/20; G06T 7/70; A63F 13/798; G06T 2219/2004

(57) ABSTRACT

An information processing system includes processing circuitry configured to store a skill related to an action in a virtual space; store a trigger condition associated with the skill, the trigger condition being related to an object in the virtual space; determine, in a case that the skill is associated with an avatar, whether the trigger condition is satisfied; and control, in a case that the trigger condition is determined to be satisfied, the avatar to perform the action based on the skill.

### CROSS-REFERENCE TO RELATED APPLICATIONS

The present application claims priority to U.S. Provisional Application No. 63/370,118, filed on Aug. 2, 2022, and Japanese Application No. 2022-200899, filed Dec. 16, 2022 the entire contents of both being incorporated by reference.

### BACKGROUND

### 1. Technical Field

The present disclosure relates to an information processing system, a method for processing information, and a non-transitory computer-readable information storage medium.

### 2. Description of the Related Art

Conventionally, one known technique is to calculate an interval between a first body part of a first avatar object and a second body part of a second avatar object, determine whether a predetermined condition for making a visual event feasible in a virtual space is satisfied, and, if it is determined that the predetermined condition is satisfied, implement the visual event in the virtual space in response to the calculated interval becoming less than or equal to a predetermined interval.

### SUMMARY

An information processing system includes processing circuitry configured to store a skill related to an action in a virtual space; store a trigger condition associated with the skill, the trigger condition being related to an object in the virtual space; determine, in a case that the skill is associated with an avatar, whether the trigger condition is satisfied; and control, in a case that the trigger condition is determined to be satisfied, the avatar to perform the action based on the skill.

### BRIEF DESCRIPTION OF THE DRAWINGS

FIG. 1 is a block diagram of a virtual reality generation system according to an embodiment;

FIG. 2 is a diagram illustrating a terminal image viewable through a head-mounted display;

FIG. 3 is a diagram illustrating a terminal image viewable on a smartphone;

FIG. 4 is an illustration of an action based on the predetermined skill “soccer ball juggling”;

FIG. 5 is an illustration of an action based on the predetermined skill “playing the piano”;

FIG. 6 is an illustration of an action based on the predetermined skill “band performance”;

FIG. 7 is a view illustrating an example of a screen (user interface) for selecting a predetermined skill;

FIG. 8A is a view illustrating a predetermined skill related to a way of walking (“walking with a long stride”);

FIG. 8B is a view illustrating a predetermined skill related to a way of walking (“walking gracefully”);

FIG. 9A is a view illustrating an example of an articulated model;

FIG. 9B is a view illustrating a relationship between body parts using the articulated model;

FIG. 10 is a view illustrating a change in the movement of a finger;

FIG. 11 is a diagram illustrating functions suitable for reflecting the characteristics of an avatar;

FIG. 12 is a diagram illustrating periods suitable for reflecting the characteristics of an avatar;

FIG. 13 is a schematic flowchart illustrating an example of a process for a specific rendering method when the predetermined skill is a performance of a musical instrument;

FIG. 14 is a view illustrating synchronized playback by a plurality of avatars;

FIG. 15 is a schematic block diagram illustrating the functions of a server device related to an action of an avatar based on a predetermined skill;

FIG. 16 is a diagram illustrating an example of data in an object information storage unit;

FIG. 17 is a diagram illustrating an example of data in a skill-related data storage unit;

FIG. 18 is a diagram illustrating an example of data in a user information storage unit;

FIG. 19 is a diagram illustrating an example of data in an avatar information storage unit;

FIG. 20 is a flowchart schematically illustrating an example of the operation of the virtual reality generation system related to an action of an avatar based on a predetermined skill;

FIG. 21 is a schematic flowchart illustrating an example rendering process related to a target avatar, which is executed in relation to the process illustrated in FIG. 20; and

FIG. 22 is a schematic flowchart illustrating an example of an animation playback process (step S234 in FIG. 21).

### DETAILED DESCRIPTION

In the related art as described above, it is difficult to effectively promote the activities of avatars in a virtual space.

Accordingly, an aspect provides effective promotion of the activities of avatars in a virtual space.

An aspect provides an information processing system. The information processing system includes an avatar processing unit configured to process an action of an avatar in a virtual space, a first storage unit configured to store a predetermined skill related to the action of the avatar and associable with the avatar, a second storage unit configured to store a trigger condition associated with the predetermined skill, and a determination unit configured to determine whether the trigger condition is satisfied when the predetermined skill is associated with a target avatar. The trigger condition is related to a predetermined object in the virtual space. The avatar processing unit is configured to cause the target avatar to perform an action based on the predetermined skill when the trigger condition is satisfied.

An aspect provides a non-transitory computer-readable information storage medium having computer-executable instructions that, when executed by one or more processors of an information processing system, cause the one or more processors to execute avatar processing for processing an action of an avatar in a virtual space; and execute determination processing. The determination processing includes determining whether a predetermined skill related to the action of the avatar in the virtual space is associated with a target avatar, and determining, when the predetermined skill is associated with the target avatar, whether a trigger condition associated with the predetermined skill and related to a predetermined object in the virtual space is satisfied. The avatar processing includes causing the target avatar to perform an action based on the predetermined skill when the trigger condition is satisfied.

An aspect provides a method for processing information, executed by a computer. The method includes executing avatar processing for processing an action of an avatar in a virtual space; and executing determination processing. The determination processing includes determining whether a predetermined skill related to the action of the avatar in the virtual space is associated with a target avatar, and determining, when the predetermined skill is associated with the target avatar, whether a trigger condition associated with the predetermined skill and related to a predetermined object in the virtual space is satisfied. The avatar processing includes causing the target avatar to perform an action based on the predetermined skill when the trigger condition is satisfied.

In an aspect, the present disclosure enables effective promotion of the activities of avatars in a virtual space.

Some embodiments will be described in detail hereinafter with reference to the accompanying drawings. In the accompanying drawings, for simplicity of illustration, only some of a plurality of body parts having the same attributes may be labeled with reference numerals.

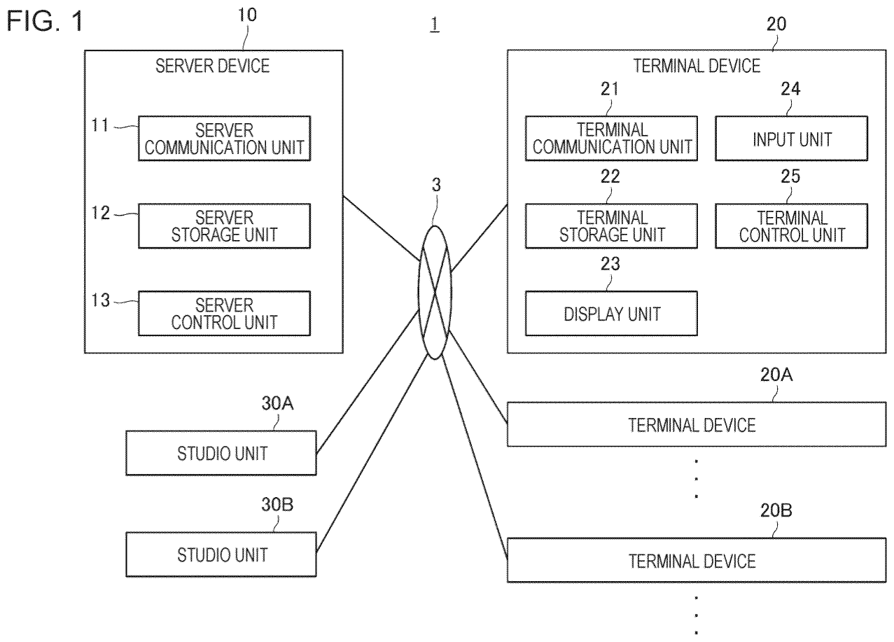

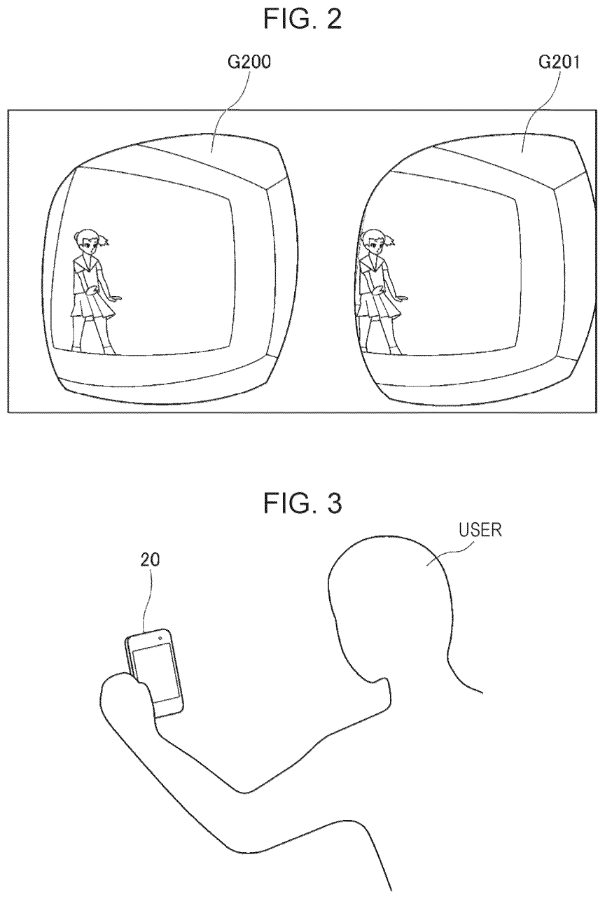

An overview of a virtual reality generation system 1 according to an embodiment will be described with reference to FIG. 1. FIG. 1 is a block diagram of the virtual reality generation system 1 according to the present embodiment. FIG. 2 is a diagram illustrating a terminal image viewable through a head-mounted display.

The virtual reality generation system 1 includes a server device 10 and one or more terminal devices 20. FIG. 1 illustrates three terminal devices 20, 20A, and 20B, for simplicity. In one example, the virtual reality generation system 1 includes two or more terminal devices 20.

The server device 10 is, for example, an information processing system such as a server managed by a service provider who provides one or more virtual reality services. The terminal device 20 is a device to be used by a user. Examples of the terminal device 20 include a mobile phone, a smartphone, a tablet terminal, a personal computer (PC), a head-mounted display, and a video game device. Typically, a plurality of terminal devices 20 are connectable to the server device 10 via a network 3 in a mode that differs from user to user.

The terminal devices 20 are each capable of implementing a virtual reality application according to the present embodiment. Each of the terminal device 20 may receive the virtual reality application from the server device 10 or a predetermined application distribution server via the network 3. Alternatively, the virtual reality application may be stored in advance in a storage device included in each of the terminal devices 20 or a storage medium such as a memory card readable by each of the terminal devices 20. The server device 10 and the terminal devices 20 are communicably connected to each other via the network 3. For example, the server device 10 and the terminal devices 20 jointly execute various processes for virtual reality.

The terminal devices 20 are communicably connected to each other through the server device 10. In the following description, the phrase “a terminal device 20 transmits information to another terminal device 20” means “a terminal device 20 transmits information to another terminal device 20 through the server device 10”. Likewise, the phrase “a terminal device 20 receives information from another terminal device 20” means “a terminal device 20 receives information from another terminal device 20 through the server device 10”. In a modification, however, the terminal devices 20 may be communicably connected to each other without the intervention of the server device 10.

The network 3 may include a wireless communication network, the Internet, a virtual private network (VPN), a wide area network (WAN), a wired network, any combination thereof, or the like.

In the example illustrated in FIG. 1, the virtual reality generation system 1 includes studio units 30A and 30B. The studio units 30A and 30B are host devices, like the terminal device 20A acting as the host. The studio units 30A and 30B may be placed in content production studios, rooms, halls, or the like. The studio units 30A and 30B may be provided with various pieces of equipment for motion capture.

The studio units 30A and 30B can have functions similar to those of the terminal device 20A acting as the host and/or the server device 10. In the following description, to distinguish between the host and participants, the mode of streaming various types of content from the terminal device 20A as the host to the terminal device 20B as a participant through the server device 10 will mainly be described, for simplicity of the description. However, alternatively or additionally, the studio units 30A and 30B facing host users may have functions similar to those of the terminal device 20A acting as the host and stream various types of content to the terminal device 20B as a participant through the server device 10. In a modification, the studio unit 30A and 30B are optional in the virtual reality generation system 1.

In the following description, the virtual reality generation system 1 implements an example of an information processing system. However, the elements of a specific terminal device 20, namely, a terminal communication unit 21, a terminal storage unit 22, a display unit 23, an input unit 24, and a terminal control unit 25 illustrated in FIG. 1, may implement an example of an information processing system, or a plurality of terminal devices 20 may jointly implement an example of an information processing system. Alternatively, the server device 10 may solely implement an example of an information processing system, or the server device 10 and one or more terminal devices 20 may jointly implement an example of an information processing system.

An overview of virtual reality according to the present embodiment will now be described. The virtual reality according to the present embodiment simulates the real world and is used for any purpose such as education, travel, role playing, simulations, or entertainment such as a video game or a concert. Virtual reality media, such as avatars, are used in virtual reality implementations. For example, the virtual reality according to the present embodiment may be implemented by a three-dimensional virtual space, various virtual reality media appearing in the virtual space, and various types of content provided in the virtual space.

The virtual reality media are electronic data used in virtual reality environments, and include cards, items, points, currencies in services (or currencies in virtual reality), tokens (e.g., non-fungible tokens (NFTs)), tickets, characters, avatars, parameters, and other media. The virtual reality media may be virtual-reality-related information such as level information, status information, parameter information (such as a physical strength value and offensive skills), or capability information (such as skills, abilities, magic spells, and jobs). While the virtual reality media are electronic data that can be acquired, owned, used, managed, exchanged, combined, enhanced, sold, discarded, or donated by users in virtual reality environments, the mode of using the virtual reality media is not limited to those specified herein.

The avatars are typically characters facing front, and may be in the form of people, animals, or the like. The avatars can have a variety of appearances (appearances when rendered) by being associated with various avatar items. In the following description, users and avatars may be identified as being identical because of the nature of the avatars. Therefore, for example, the phrase “an avatar does something” may be synonymous with the phrase “a user does something”.

Each user may wear a wearable device on the head or part of the face and view the virtual space through the wearable device. The wearable device may be a head-mounted display or a glasses-type device. The glasses-type device may be so-called augmented reality (AR) glasses or mixed reality (MR) glasses. In any case, the wearable device may be different from the terminal device 20, or may implement some or all of the functions of the terminal device 20. The terminal device 20 may be implemented by a head-mounted display.

Configuration of Server Device

The configuration of the server device 10 will be specifically described. In one example, the server device 10 includes one or more server computers. The server device 10 may be implemented jointly by a plurality of server computers. For example, the server device 10 may be implemented jointly by a server computer that provides various types of content, a server computer that implements various authentication servers, and the like. Further, the server device 10 may include a web server. In this case, some of the functions of the terminal device 20, which will be described below, may be implemented by a browser processing Hypertext Markup Language (HTML) documents received from the web server and various programs (JavaScript) associated with the HTML documents.

As illustrated in FIG. 1, the server device 10 includes a server communication unit 11, a server storage unit 12, and a server control unit 13.

The server communication unit 11 includes an interface that communicates with an external device in wireless or wired mode to transmit and receive information. The server communication unit 11 may include, for example, a wireless local area network (LAN) communication module or a wired LAN communication module. The server communication unit 11 is capable of transmitting and receiving information to and from the terminal device via the network 3.

The server storage unit 12 is, for example, a storage device, and stores various kinds of information and programs used for various types of processing related to virtual reality.

The server control unit 13 may include a dedicated microprocessor, a central processing unit (CPU) that implements a specific function by reading a specific program, a graphics processing unit (GPU), or the like. For example, the server control unit 13 cooperates with the terminal device 20 and implements a virtual reality application in response to a user input.

Configuration of Terminal Device

The configuration of the terminal device 20 will be described. As illustrated in FIG. 1, the terminal device 20 includes a terminal communication unit 21, a terminal storage unit 22, a display unit 23, an input unit 24, and a terminal control unit 25.

The terminal communication unit 21 includes an interface that communicates with an external device in wireless or wired mode to transmit and receive information. The terminal communication unit 21 may include, for example, a wireless communication module supporting a mobile communication standard such as Long Term Evolution (LTE), LTE-Advanced (LTE-A), a fifth-generation mobile communication system, or Ultra Mobile Broadband (UMB), a wireless LAN communication module, a wired LAN communication module, or the like. The terminal communication unit 21 is capable of transmitting and receiving information to and from the server device 10 via the network 3.

The terminal storage unit 22 includes, for example, a primary storage device and a secondary storage device. For example, the terminal storage unit 22 may include a semiconductor memory, a magnetic memory, an optical memory, or the like. The terminal storage unit 22 stores various kinds of information and programs received from the server device 10 and used for the processing of virtual reality. The information and programs used for the processing of virtual reality may be acquired from an external device through the terminal communication unit 21. For example, a virtual reality application program may be acquired from a predetermined application distribution server. The application program is hereinafter also referred to simply as an application.

Further, the terminal storage unit 22 may store data for rendering virtual spaces, for example, images of indoor spaces such as the inside of buildings and outdoor spaces. The data for rendering virtual spaces may be prepared such that each virtual space is associated with a plurality of types of data for rendering the virtual space, and the plurality types of data may be selectively used.

The terminal storage unit 22 may further store various images (texture images) to be projected (texture-mapped) onto various objects arranged in three-dimensional virtual spaces.

For example, the terminal storage unit 22 stores avatar rendering information related to avatars serving as virtual reality media associated with the respective users. An avatar in a virtual space is rendered based on avatar rendering information related to the avatar.

Further, the terminal storage unit 22 stores rendering information related to various objects (virtual reality media) different from avatars. Examples of such objects include various gift objects, buildings, walls, and non-player characters (NPCs). Various objects in virtual spaces are rendered based on such rendering information. The gift objects are each an object corresponding to a gift from one user to another and are a kind of item. The gift objects may include objects (such as clothes and accessories) that avatars wear, objects that decorate avatars (such as fireworks and flowers), backgrounds (such as wallpapers) and similar objects, and tickets and similar objects for playing Gacha games (or lotteries). The term “gift”, as used herein, refers to a similar concept to the term “token”. Therefore, the term “gift” may be interchangeably used with the term “token” to understand the technology described herein.

The display unit 23 includes a display device such as a liquid crystal display or an organic electroluminescent (EL) display, for example. The display unit 23 is capable of displaying various images. The display unit 23 includes, for example, a touch panel, and functions as an interface for detecting various user operations. As described above, the display unit 23 may be incorporated in the head-mounted display.

The input unit 24 may include physical keys, and may further include any input interface including a pointing device such as a mouse. Further, the input unit 24 may be capable of receiving contactless user inputs such as voice inputs, gesture inputs, and gaze inputs. A sensor (such as an image sensor, an acceleration sensor, or a distance sensor) for detecting various states of the user, a dedicated motion capture device that combines a camera with sensor technology, a controller such as a joypad, or the like may be used for the gesture inputs. A camera for gaze detection may be included in the head-mounted display. As described above, the various states of the user include, for example, the orientation, the position, the motion, or the like of the user. The orientation, the position, and the motion of the user are concepts including not only the orientation, the position, and the motion of the entire body of the user or part of the body of the user, such as the face or the hands, but also the orientation, the position, the motion, or the like of the gaze of the user.

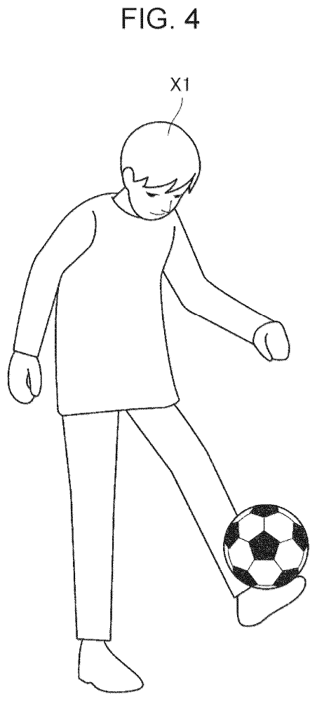

A gesture-based user input may be used to change the gaze of the virtual camera. For example, as schematically illustrated in FIG. 3, in response to the user changing the orientation of the terminal device 20 while holding the terminal device 20 with their hand, the gaze of the virtual camera may be changed in accordance with the changed in the orientation of the terminal device 20. In this case, even when the terminal device 20 having a relatively small screen, such as a smartphone, is used, a certain size of the viewing area can be secured in a manner similar to that in which the surroundings can be viewed through the head-mounted display.

The terminal control unit 25 includes one or more processors. The terminal control unit 25 controls the overall operation of the terminal device 20.

The terminal control unit 25 transmits and receives information through the terminal communication unit 21. For example, the terminal control unit 25 receives various kinds of information and programs used for various types of processing related to virtual reality from at least either the server device 10 or another external server. The terminal control unit 25 stores the received information and programs in the terminal storage unit 22. The terminal storage unit 22 may store, for example, a browser (Internet browser) for connecting to a web server.

The terminal control unit 25 activates a virtual reality application in response to a user operation. The terminal control unit 25 cooperates with the server device 10 and executes various types of processing related to virtual reality. For example, the terminal control unit 25 causes the display unit 23 to display an image of a virtual space. For example, a graphical user interface (GUI) for detecting a user operation may be displayed on a screen. The terminal control unit 25 is capable of detecting user operations through the input unit 24. For example, the terminal control unit 25 is capable of detecting various user operations (operations corresponding to a tap, a long tap, a flick, a swipe, and the like) performed through gestures. The terminal control unit 25 transmits operation information to the server device 10.

The terminal control unit 25 renders an avatar or the like together with a virtual space (image) to produce a terminal image, and causes the display unit 23 to display the terminal image. In this case, for example, as illustrated in FIG. 2, images G200 and G201 to be viewed by the left and right eyes, respectively, may be generated to produce a stereoscopic image for a head-mounted display. FIG. 2 schematically illustrates the images G200 and G201 to be viewed by the left and right eyes, respectively. In the following description, an image of a virtual space refers to the entire image represented by the images G200 and G201, unless otherwise specified. Further, the terminal control unit 25 implements various actions and the like of the avatar in the virtual space in response to various operations performed by the user, for example.

The functions implemented by the components described herein, such as the server control unit 13 and the terminal control unit 25, may be implemented by circuitry or processing circuitry programmed to implement the functions described herein. The circuitry or processing circuitry includes a general-purpose processor, a special-purpose processor, an integrated circuit, an application-specific integrated circuit (ASIC), a CPU, an existing circuit, and/or a combination thereof. A processor includes transistors and other circuits and is considered as circuitry or processing circuitry. The processor may be a programmed processor that executes a program stored in a memory.

As used herein, circuitry, units, and means are hardware programmed or otherwise configured to implement the functions described herein. The hardware may be any type of hardware disclosed herein or any type of hardware known to be programmed or otherwise configured to implement the functions described herein.

When the hardware is a processor considered as circuitry, the circuitry, means, or units are combinations of hardware and software used to construct the hardware and/or the processor.

A virtual space, which will be described below, is a concept including not only an immersive space but also a non-immersive space. The immersive space is visible using a head-mounted display or the like and is a three-dimensional continuous space in which the user can move around freely (as in reality) as an avatar. The non-immersive space is visible using a smartphone or the like, as described above with reference to FIG. 3. The non-immersive space visible using a smartphone or the like may be a three-dimensional continuous space in which the user can move around freely as an avatar, or may be a two-dimensional discontinuous space. In the following description, the three-dimensional continuous space in which the user can move around freely as an avatar (e.g., a 3D avatar) is also referred to as a “metaverse space”, and other virtual spaces (e.g., a discontinuous space) are also referred to as “non-metaverse spaces” to distinguish the three-dimensional continuous space from otherwise spaces.

In such various virtual spaces, a wide variety of users can exist. For example, a streaming user refers to a user who transmits information related to video and/or audio. In one example, a streaming user may be, for example, a user who organizes or holds video streaming solely, collaborative streaming that a plurality of people can join, a video chat or a voice chat that a plurality of people can join and/or view, or an event (such as a party) in a virtual space that a plurality of people can join and/or view, that is, a user who hosts such events. Therefore, a streaming user in the present disclosure can also be referred to as a host user, an organizing user, a holding user, or the like.

In contrast, a viewing user refers to a user who receives information related to video and/or audio. However, a viewing user may be a user who can not only receive the information described above but also react to the information described above. For example, a viewing user is a user who views a streaming video or a collaborative streaming session, or a user who joins and/or views a video chat, a voice chat, or an event. Therefore, a viewing user in the present disclosure can also be referred to as a guest user, a participant user, a listener, a browsing user, a supporter user, or the like.

Further, an information processing system according to an embodiment of the present disclosure can be used to provide the next Internet space (metaverse) where many people can perform social activities regardless of the differences between real and virtual worlds. The next Internet space (metaverse) is a digital world that many people can simultaneously join to perform free virtual activities, such as interaction, work, and play, on a level close to those in the real world through character objects (avatars).

In such a metaverse space, avatars of users can freely walk around in a world and communicate with one another.

One avatar (character object) among the plurality of avatars in the metaverse space may be able to stream a video as a character object of a streaming user. That is, one-to-many video streaming may be feasible in a many-to-many metaverse space.

In such a metaverse space, streaming users and viewing users are not distinguishable from each other.

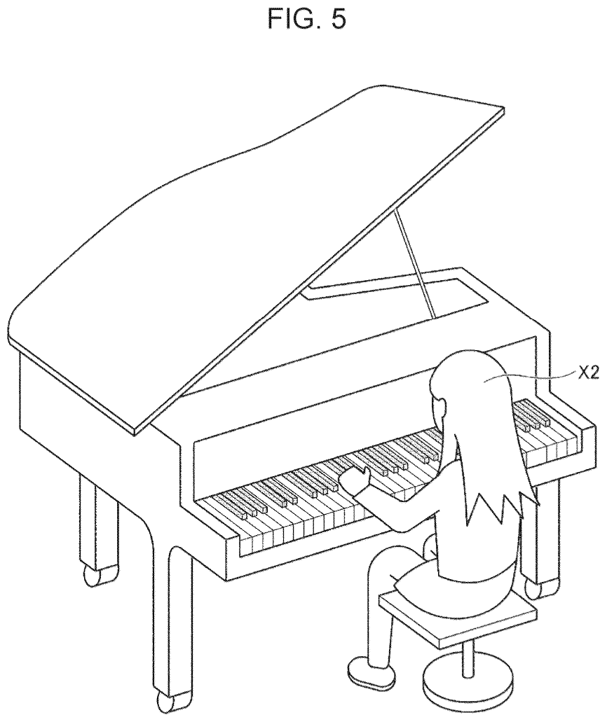

Next, a characteristic configuration related to actions of avatars in virtual spaces will be described with reference to FIGS. 4 to 13. The technique described hereinafter is applicable not only to a metaverse space but also to a non-metaverse space (e.g., a space where streaming users and viewing users are present).

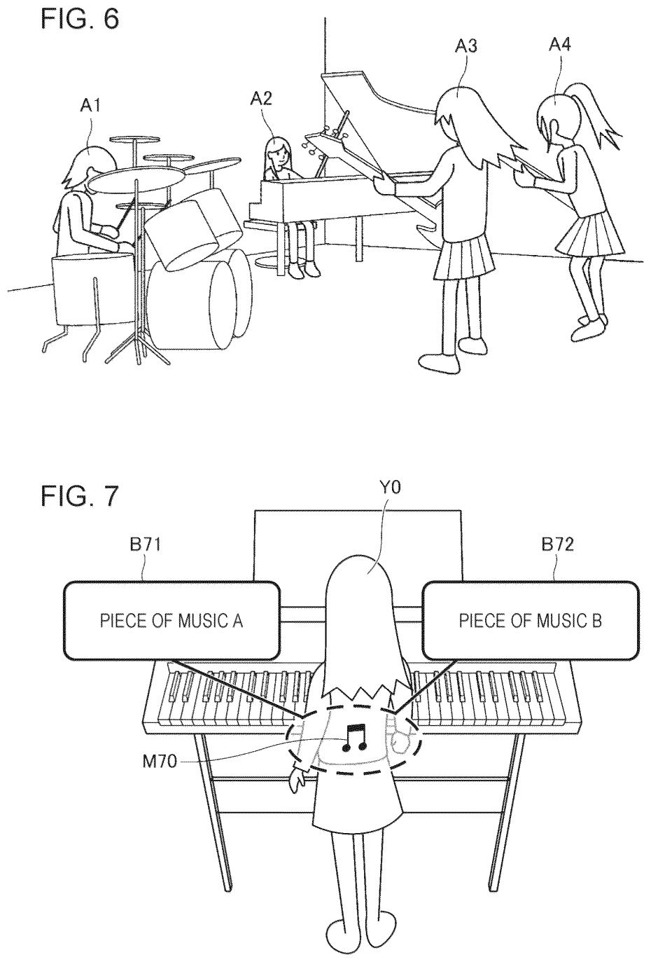

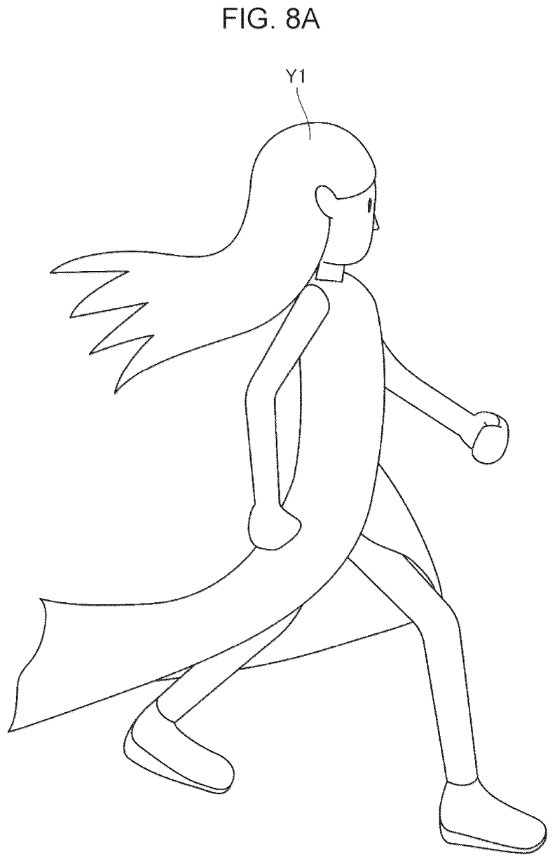

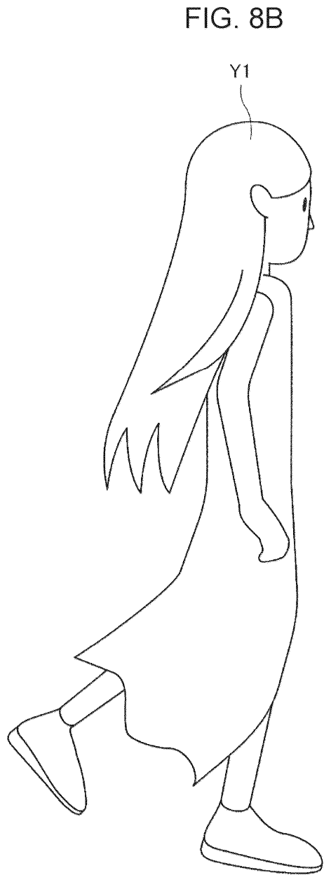

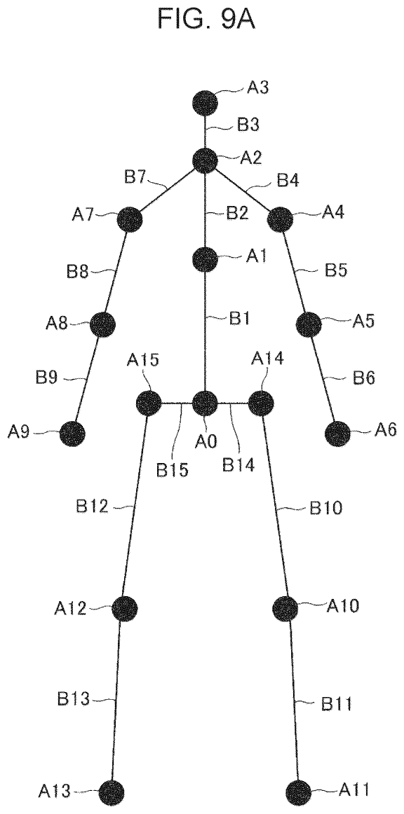

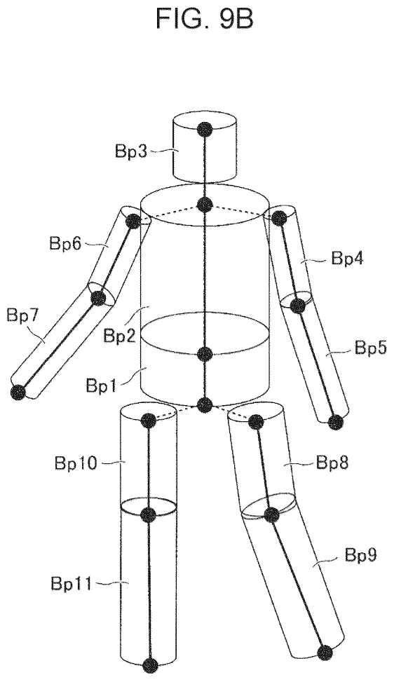

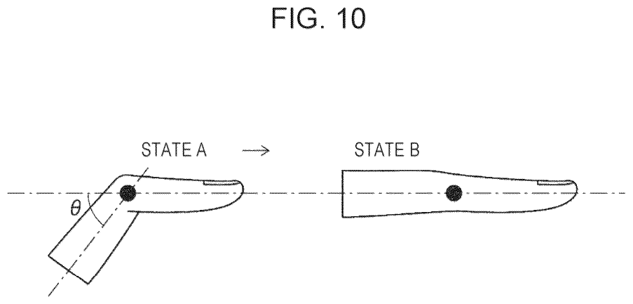

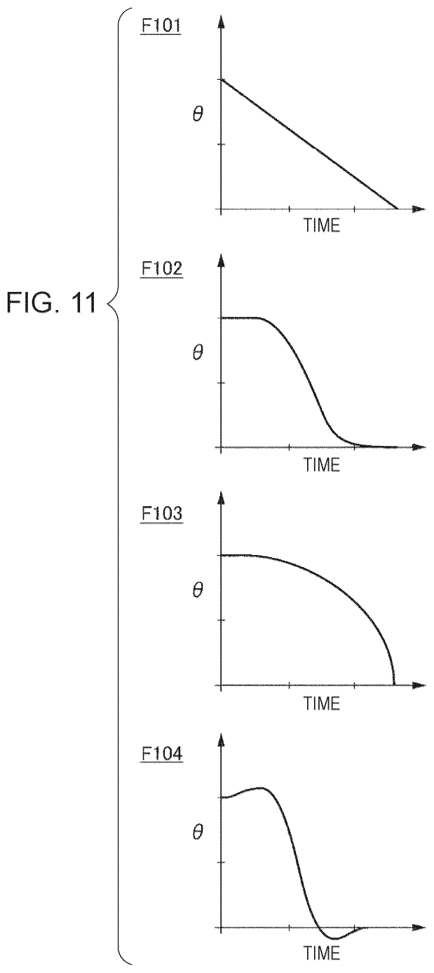

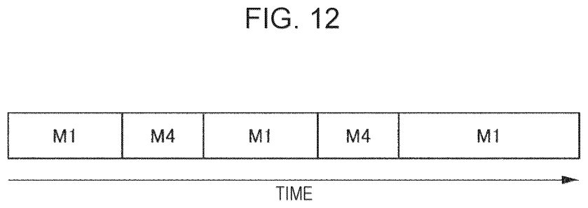

FIG. 4 is an illustration of an action based on the predetermined skill “soccer ball juggling”, and illustrates an avatar X1 juggling a soccer ball. FIG. 5 is an illustration of an action based on the predetermined skill “playing the piano”, and illustrates an avatar X2 playing the piano. FIG. 6 is an illustration of an action based on the predetermined skill “band performance”, and FIG. 7 is a view illustrating an example of a screen (user interface) for selecting a predetermined skill. FIGS. 8A and 8B are views illustrating predetermined skills related to ways of walking. FIG. 9A is a view illustrating an example of an articulated model, and FIG. 9B is a view illustrating a relationship between body parts using the articulated model. FIG. 10 is a view illustrating a change in the movement of a finger. FIG. 11 is a diagram illustrating functions suitable for reflecting the characteristics of an avatar. FIG. 12 is a diagram illustrating periods suitable for reflecting the characteristics of an avatar. In the present embodiment, as will be described below, the term “characteristics of an avatar” refers to a “switching algorithm for automation of operational expressions with detailed motions among the behaviors of the avatar”.

In the following description, various objects (such as a soccer ball and a piano) are objects in virtual spaces and are different from those in the real world, unless otherwise specified. Further, various events in the following description are various events (such as a concert) in virtual spaces and are different from those in the real world. In the following description, furthermore, the phrase “an avatar acquires (or obtains) an object” represents a transition from a state in which the object is not associated with the avatar to a state in which the object is associated with the avatar. In addition, as described above, since an avatar and a user associated with the avatar can be identified as being identical, the avatar and the user may be described without distinction therebetween. In some cases, a single user may be associated with a plurality of avatars. Also in such cases, the user selects one of the avatars and acts in a virtual space. Therefore, also in this case, an avatar and a user associated with the avatar can be identified as being identical at each point in time.

In the present embodiment, actions of an avatar in a virtual space include normal actions based on user inputs from a user and actions based on predetermined skills. The term “action” refers to a concept including not only an action involving a movement of an avatar but also an action not involving a movement of the avatar. Examples of the action not involving a movement of the avatar include an action of uttering with the voice.

The actions based on the predetermined skills are actions not available to avatars with which the predetermined skills are not associated, and only avatars with which the predetermined skills are associated are allowed to perform the actions.

The content, attributes, and the like of the predetermined skills are not limited. The predetermined skills include, for example, sports-related skills such as juggling a soccer ball, shooting a soccer ball, and overhead-kicking a soccer ball, as schematically illustrated in FIG. 4, art-related skills such as playing the piano, as schematically illustrated in FIG. 5, cooking-related skills, performance-related skills, skills related to singing ability or voice volume, entertainment-related skills such as performing magic, game-related skills such as transforming, saying a magic spell, and conjuring illusions, and skills related to driving vehicles such as a car. FIG. 6 schematically illustrates a performance scene with four avatars A1 to A4 associated with skills to play various musical instruments.

In the present embodiment, it is assumed that a plurality of types of predetermined skills are used and are associated with avatars satisfying predetermined acquisition conditions. The predetermined acquisition conditions may be set for the respective predetermined skills or for the respective attributes of the predetermined skills. The predetermined acquisition conditions are not limited, and may include conditions based on consumption, exchange, or the like of virtual reality media (e.g., virtual currency), conditions based on activities of avatars in the virtual space, conditions based on predetermined items associated with avatars, and combinations thereof. For example, in the case of the predetermined skill “soccer ball juggling” illustrated in FIG. 4, a predetermined acquisition condition for the predetermined skill may be to acquire (possess) a specific soccer ball or to acquire (possess) a certificate (predetermined item) of a soccer school or the like. In the case of the predetermined skill “playing the piano” illustrated in FIG. 5, a predetermined acquisition condition for the predetermined skill may be to acquire (possess) a specific piano or to acquire (possess) a certificate (predetermined item) of a piano school or the like. A predetermined acquisition condition may be associated with training for acquiring actual knowledge or skills by viewing an e-learning video, or may be given by viewing an advertisement such as an advertising video (for sports goods, a musical instrument, or the like). Alternatively, a predetermined acquisition condition may be interpreted as attaining a certificate from the outside of the system using an NFT marketplace, in addition to acquiring items in the system. A predetermined acquisition condition may further be associated with the history of blockchains or the like created by an actual educational institution, and may be given with a certificate of a course or a certification examination.

The granularity of the predetermined skills is set as desired. In the case of soccer ball juggling illustrated in FIG. 4, the predetermined skill may be assigned finer granularities such that different granularities are set for various skills for juggling (e.g., skills with different levels of difficulty). Alternatively, the predetermined skill may be assigned a coarser granularity such that the predetermined skill is a skill of soccer ball handling (such as dribbling). In the case of playing the piano illustrated in FIG. 5, the predetermined skill may be assigned different granularities for respective pieces of music (e.g., pieces of music with different levels of difficulty). In this case, the predetermined acquisition condition for the predetermined skill may be to acquire (possess) the score of each piece of music or to acquire (possess) a cassette tape (predetermined item) of each piece of music.

While the predetermined skill is associated with each avatar, one predetermined skill may be associated with a plurality of avatars. Examples of the predetermined skill associable with a plurality of avatars include a predetermined skill related to a collaborative performance (band performance) as illustrated in FIG. 6, for example. A sports-related predetermined skill associable with a plurality of avatars may include a collaborative skill performed by a plurality of players. Examples of the collaborative skill include passing a soccer ball from avatar to avatar, playing catch with a baseball, and hitting tossed balls. Other examples of the sports-related predetermined skill may include playing tug of war, a three-legged race, and playing jumping rope. Such collaboration may be performed by using the studio unit 30A or 30B or the like, or may occur spontaneously. The proficiency of a skill for collaboration may be set according to a collaborative or cooperative play game with a different level of difficulty, such as “rhythm game”, “rock-paper-scissors”, or “Acchimuite-hoi (a popular game in Japan; a combination of rock-paper-scissors and “look away”)”. In this case, in addition to the proficiency of the skill performed by each user alone, an improvement in the skill performed in collaboration with an individual partner for the duration of play time may be set. This achieves the effect of an increase in the amount of game play time and in-game currency consumption, a substantial improvement in communication between users, and elimination of cheating.

In the present embodiment, the actions based on the predetermined skills include an action that can be rendered in animation. The action that can be rendered in animation is an action that can be rendered regardless of a user input from the user. Thus, not all of the movements of the user need to be tracked, and the processing load can be reduced. The movement of the avatar in which the characteristics of the user are efficiently reflected can be expressed. In particular, even if the actions based on the predetermined skills involve a complicated action, the processing load for the rendering can be reduced. That is, the actions based on the predetermined skills can be precisely rendered with a reduced processing load for rendering. In addition, since the types of the actions based on the predetermined skills are different according to the predetermined skill acquired by the user, an expression that reflects the characteristics of the user can be achieved.

As a non-limiting example, a game for improving the skill for collaboration described above is “rock-paper-scissors”. In the “rock-paper-scissors” game, rendering and network processing can be performed for two persons. It is not reasonable to continuously transmit such motion data that requires a high-quality and high-speed expression with a body part to a large number of people in a space via the Internet in real time. However, the acquisition of this skill eliminates tracking and sharing of all the complicated movements, but enables description using differences that can express characteristics in the motion data and using symbolic expressions (a combination of the rock, paper, and scissors symbols for “rock, scissors, paper”) used for the game system, with a reduced load.

The actions based on the predetermined skills may be triggered (automatically), regardless of a subsequent user input from the user, when a predetermined trigger condition is satisfied. Alternatively, when a predetermined trigger condition is satisfied, the actions based on the predetermined skills may be triggered in response to a subsequent predetermined input (an input for instructing triggering) from the user. The difference between automatic triggering and non-automatic triggering may depend on the attribute of the predetermined skill.

The predetermined trigger condition is related to a predetermined object in the virtual space. The predetermined object is not limited, and may be related to a corresponding predetermined skill. For example, when the predetermined skill is soccer ball juggling illustrated in FIG. 4, the predetermined trigger condition may be related to a soccer ball (object) as the predetermined object. For example, the predetermined trigger condition may be satisfied when the positional relationship between the predetermined object and a predetermined body part of the avatar meets a predetermined condition. The predetermined condition is not limited, and may include a decrease in the distance between the predetermined object and the predetermined body part of the avatar. Examples of the predetermined condition include a condition in which the distance is less than a threshold, a condition in which the predetermined body part of the avatar is located within a predetermined range around the predetermined object, and a condition in which the difference in distance between the coordinates of the predetermined body part of the avatar located in the virtual space and the coordinates of the predetermined object located in the virtual space satisfies a predetermined condition. The predetermined condition may be adapted for each predetermined skill to implement a natural movement of the avatar with respect to the predetermined object. For example, the predetermined trigger condition may be satisfied when the avatar drops the soccer ball to the avatar's own foot. When the predetermined skill is playing the piano as illustrated in FIG. 5, the predetermined trigger condition may be satisfied when the avatar sits at the piano with a score placed thereon and places the avatar's hands on the piano.

Predetermined objects to which predetermined trigger conditions are related may differ from one predetermined trigger condition to another, or a common (the same) predetermined trigger condition may be related to a plurality of predetermined trigger conditions. That is, a common (the same) predetermined trigger condition with which a plurality of predetermined skills are associated may be common (the same) between or among different predetermined objects. In this case, in one example, a plurality of types of scores (i.e., predetermined skills) of pieces of music that can be played with the predetermined object such as the piano may be associated with the predetermined object. In another example, a plurality of predetermined skills such as juggling, dribbling, and shooting may be associated with a soccer ball (object). In this case, when the avatar and the object (the piano or the soccer ball in each of the examples) are located within a predetermined distance, the common predetermined trigger condition is satisfied.

When a plurality of types of predetermined skills associated with a single avatar are associated with a common, or the same, predetermined trigger condition, the avatar may be able to select one or more of the plurality of types of predetermined skills when the predetermined trigger condition is satisfied. In this case, an action based on the one or more types of predetermined skills selected by the avatar may be implemented. If two or more types of predetermined skills are selected, actions based on the selected predetermined skills may be implemented in order, or may be implemented in combination.

In the example illustrated in FIG. 7, a user interface represented by a musical note mark M70 appears when the predetermined trigger condition is satisfied. The user interface represented by the musical note mark M70 includes user interfaces B71 and B72 to make it possible to select one of two pieces of music (a “piece of music A” and a “piece of music B”) as a predetermined skill of an avatar Y0. The user interface represented by the musical note mark M70 and/or the user interfaces B71 and B72 may appear automatically when the predetermined trigger condition is satisfied, or may appear in response to a user input from the user. When a plurality of types of predetermined skills associated with a common predetermined trigger condition are associated with a single avatar, all of the plurality of types of predetermined skills may be selectable, or one or more of the plurality of types of predetermined skills may be selectable. In this case, the selectable type(s) of predetermined skill(s) may be changed in accordance with the attribute of the avatar or the costume of the avatar. For example, when the costume of the avatar is “formal attire”, a piece of high-class music may be selectable. When the costume of the avatar is “heavy metal costume”, a piece of rock music may be selectable.

Further, one predetermined trigger condition may be simultaneously related to two or more predetermined objects. For example, one predetermined trigger condition may include a condition in which an avatar possessing one predetermined object approaches another predetermined object.

Further, a plurality of trigger conditions may be associated with one predetermined skill. For example, for the skill “running”, a plurality of trigger conditions such as wearing pants, wearing sneakers, and wearing a jersey may be set. In this case, a plurality of trigger conditions associated with one common predetermined skill are related to different predetermined objects. That is, in the example described above, the predetermined objects related to the plurality of trigger conditions are pants, sneakers, and a jersey, which are different from each other.

Further, the predetermined trigger condition may be related to the predetermined object itself, or may be related to an action, a movement, or the like of the predetermined object. For example, in the case of the predetermined skill “automatic reaction”, the predetermined trigger condition may be satisfied when a specific avatar is in a predetermined positional relationship with the predetermined object and performs a specific action. In this case, the automatic reaction may reflect characteristics of the avatar. Examples of the automatic reaction include a “modest reaction”, an “exaggerated reaction”, and a “cold reaction”. When a plurality of types of automatic reactions are associated with a single avatar as predetermined skills, the avatar may be able to select a type of automatic reaction. At this time, a selectable type of predetermined skill may be restricted in accordance with the attribute of the avatar or the costume of the avatar. For example, if the costume of the avatar is a kimono (a Japanese traditional garment), a restriction is imposed such that only the “modest reaction” can be selected.

The automatic reaction will be described further. The intensity or frequency of the automatic reaction may be based on the social graph used in social network services (SNSs), specifically, the past contact history, and may be changed depending on the relationship between the user and people to whom the user reacts, such as new people, acquaintances, close friends, or famous people whom the user personally follows, or the distance in the social graph. For example, an avatar with a skill of “oshikatsu”, which is an activity of enthusiastically supporting someone who is liked or admired, and set as a “modest” character performs a reaction such that when the “famous person” who is liked or admired (for whom the number of follows is very smaller than the number of followers) comes in sight, an immodest motion, such as “largely shaking hands with its heart-marked eyes”, is automatically played back and, otherwise, a normal action is performed for other users. Further, a variety of settings with a combination of a plurality of skills or priority settings may be set such that when the skill of “ingratiatingly smiling” is high, the motion of smiling and greeting is generated for anyone; however, an avatar also having the skill of “being depressed” averts its eyes off of a user who is not close friend or shows less change in facial expression.

Further, a single predetermined trigger condition may include a condition in which two or more types of specific predetermined skills are associated with the predetermined trigger condition. In this case, restriction can be implemented such that, for example, an avatar that does not acquire both the score of a specific piece of music and the skill of playing the piano is not able to play the piano even if the avatar approaches the piano.

Further, the predetermined skills may be related to various behaviors such as walking, speaking, and eating. For example, in the case of the predetermined skill “walking gracefully (elegantly)”, the predetermined trigger condition may be related to the costume (object) of the avatar walking gracefully (elegantly) as the predetermined object. The predetermined trigger condition may be satisfied, for example, when the costume of the avatar is a costume such as a dress or kimono in which walking “gracefully (elegantly)” is suitable or required. In this case, an avatar Y1 wearing the same dress walks actively, as schematically illustrated in FIG. 8A, when the avatar Y1 is not associated with the predetermined skill “walking gracefully (elegantly)”, and walks gracefully (elegantly), as schematically illustrated in FIG. 8B, when the avatar Y1 is associated with the predetermined skill “walking gracefully (elegantly)”.

In the case of the predetermined skill “running fast”, the predetermined trigger condition may be related to the shoes (object) worn by the running avatar as the predetermined object. The predetermined trigger condition may be satisfied, for example, when the shoes worn by the avatar are specific athletic shoes. The specific athletic shoes are not limited, and may be athletic shoes having a history of being used by a user who is a famous runner (such as an Olympic medalist) based on a history of owners of the object. The predetermined skill “running fast” may be triggered in response to a predetermined input (an input for giving an instruction to “run”) from the user or an input from an acceleration sensor or the like incorporated in the terminal device 20 such as a smartphone.

Further, a selectable predetermined skill may be restricted in accordance with the attribute of the object such as the costume (object) of the avatar. For example, when an avatar associated with various predetermined skills such as “running”, “walking briskly!”, “skipping”, “walking gracefully”, and “walking with a long stride (like a man)” acquires a specific object (such as a dress, a kimono, a sportswear, a tank top, sneakers, or high heels), a list of ways of walking that are selectable with the object may be displayed. In this case, the avatar may be able to move in the way of walking selected by the user. At this time, a selectable type of predetermined skill may be restricted in accordance with the attribute of the object. For example, if the object is a kimono, a restriction is imposed such that only “skipping” and “walking gracefully” can be selected. Further, the options may be narrowed down according to the attribute (such as gender or body type) of the avatar.

In the case of the predetermined skill “karaoke”, the predetermined trigger condition may be satisfied when the avatar acquires a score, approaches a microphone (object), and picks up the microphone. In this case, a list of pieces of music in the acquired score may be displayed, and moving or dancing along with a piece of music selected by the user may be implemented as an action based on the predetermined skill. In the case of karaoke, for example, sound may be output in response to a user input. That is, the user may be able to select an option such as singing a song by themselves or outputting the sound of a performance by themselves.

In the case of the predetermined skill “transforming”, the predetermined trigger condition may be satisfied when a predetermined magic spell (virtual reality medium) is acquired. The predetermined trigger condition may be satisfied in response to, instead of acquisition of a magic spell, selection of a magic spell, that is, in response to the user making a selection from options such as “casting a magic spell” when the avatar of the user is wearing a predetermined object, or in response to an input of a magic spell, that is, in response to the user inputting a magic spell (such as “abracadabra”) by text or voice. In these cases, the avatar acquires or wears a predetermined object (such as a dress or a suit when the predetermined object is a costume) and selects a magic spell. Then, an action (e.g., an action with an effect) of transforming the avatar into a character wearing a dress or a squadron suit by taking a suitable transformation pose may be implemented as an action based on the predetermined skill. If the avatar does not have the predetermined skill “transforming” or the predetermined magic spell, the avatar may simply change clothes. In addition, the predetermined skill “transforming” may be processed for a limited period of time or a limited number of times depending on the consumption of a paid object. Alternatively, the effect of the skill may be hidden and may be displayed by another name such as “?” until processing is performed for the first time, to attract the user's interest or consume the related object.

An action based on the same predetermined skill may be common to all avatars with which the predetermined skill is associated. Different actions for individual avatars or a plurality of avatars may be based on the predetermined skill such that the characteristics of each avatar can be expressed. For example, a plurality of animations may be prepared in accordance with attributes (such as size and gender) of the avatar.

The common skill may be distributed through an external system in an NFT marketplace or the like, or may be distributed as an incentive in conjunction with an object in another game system, an advertisement, a product purchase, or the viewing of a video. At this time, an action based on such a skill may be played back as more common animation processing, or a difference in action to be played back may be allowed depending on the size (the length of the hands and legs or hair or invisible elements such as the weight) and personality of the avatar, and the attributes (such as gender, age, region, and language) of the actual user who operates the avatar. This is assumed to prevent the same gesture from having different meanings in different cultures (e.g., raising the thumb, making a circle with the fingers, raising the middle finger, raising the little finger, etc.).

As the plurality of animations, multiple types of animation data are prepared in accordance with the attribute of the avatar and an object to be worn. The attribute includes personality information, and the personality of the avatar includes, for example, hair color, clothes, and gender. For example, animation data representing an active and frequent movement may be prepared for a vigorous attribute of the avatar, and animation data representing a slow or infrequent movement may be prepared for a quiet attribute of the avatar. Further, the attribute of the avatar or an object to be worn may be set by the user by selecting the attribute (or personality) from among a plurality of options. If a plurality of avatar IDs are associated with a single user ID, the user can set attributes (or personality) for each avatar as desired.

Rendering in animation has an advantage that producing animation in advance makes real-time rendering feasible with a reduced processing load, and also has a disadvantage that the characteristics of each avatar are difficult to express.

In the present embodiment, accordingly, rendering in animation may be applied to only a portion of each body part of the avatar. At this time, first, the simplest rendering process without notice of joints will be described. For example, in a thumbs-up animation representing “like”, the right hand and the finger shapes are important body parts. In this case, the joints closer to the right fingertip than to the right wrist can be expressed by a finger shape (arrangement of bending joint angles) prepared in advance, and the joints closer to the right arm than to the right wrist can be expressed by using motion capture data or the like.

Next, the rendering process focusing on the joints will be described. Only a predetermined body part in the movable body parts of the avatar may be rendered in animation, and the other body parts may be rendered in such a manner as to move in conjunction with the movement of the predetermined body part focusing on the joints. In this case, to express the other body parts together with their positions, for example, inverse kinematics (hereinafter sometimes abbreviated as “IK”) may be used for rendering. In this case, the avatar may be expressed as any articulated model. The articulated model to be used is any model related to the joints of the avatar. For example, the articulated model is represented by a plurality of joints and bones (links) between the joints. In the present embodiment, as an example, an articulated model as illustrated in FIG. 9A is used. The articulated model as illustrated in FIG. 9A is a 16-joint model having one joint for the head, three joints for the trunk (or main body), three joints for each arm, and three joints for each leg, with the head being defined as a joint and three points including both ends and a midpoint of the other parts being defined as joints. Specifically, the articulated model includes 16 joints A0 to A15 and 15 bones B1 to B15 connecting the 16 joints. The bones B1 to B15 are also referred to as “body parts B1 to B15”. As can be understood, for example, the joints A4 and A7 are joints of the left and right shoulders, and the joint A2 is a joint of the cervical spine. The joints A14 and A15 are left and right hip joints, and the joint A0 is a joint related to the lumbar spine. In this case, as illustrated in FIG. 9B, the avatar can be rendered as a model in which a plurality of movable body parts are connected through a plurality of joints. The example illustrated in FIG. 9B presents a model in which 11 movable body part Bp1 to Bp11 of the avatar are connected through a plurality of joints (represented by black dots). Each of the movable body parts of the avatar does not necessarily correspond to a corresponding one of the actual movable body parts of the person, and some of them may be omitted or another movable body part that the person does not have, such as a wing or a tail, may be added.

Here, the rendering process may be a method other than the IK method. Examples of such a method include a method in which motion data of each body part is stored in association with a skill such that when a skill is exerted, an animation is rendered based on the motion data associated with the skill, and a method in which animation data of a skill is represented as moving image data such that when the skill is triggered, a moving image corresponding to the skill is played back. In another method, for example, an animation Graphics Interchange Format (GIF) file may be defined, and a specific moving image file may be selected and played back.

The rendering process will be described in more detail as follows.
(1) An avatar is rendered based on the animation data of each skill.
(2) The animation data includes motion data of each body part of the avatar. Based on the motion data of each skill, an avatar may be rendered, an avatar may be generated by an IK controller, or an avatar may be generated by logic.
(3) An avatar may be rendered by a method of operating the IK controller by logic or physical simulation. When an IK target in which the target is set to the bone of the starting point is moved, the bone of the starting point and the target bone are set to move in conjunction with the movement of the target.
(4) In the method described above, only the movement of the target may be set in the animation data of each skill (e.g., the movement of a ball in juggling). When the skill is triggered, the target and the bone associated with the target are moved by using the data of the movement of the target and IK set in advance for the bone of the avatar, and the avatar is rendered.
(5) Not only a structure connected as a joint, like a bone, but also the neck or gaze, an effect, or the like may be operated in a similar manner.
(6) When the skill is implemented by logic, the animation to be played back is loaded by utilizing a branch of an IF statement for each body part in the given motion data, analysis for an audio stream, image recognition of a reference music video or the like, embedded data of the lyrics or the like, or determination by machine learning using a learning set obtained by combining them.
(7) For each body part such as a hand, a leg, a foot, or the trunk, a motion may be set by using layers in Unity and an avatar mask. For example, for animation data of a certain skill, animations of some of the body parts of the avatar may be changed by setting an avatar mask and stored as separate pieces of animation data. The motion set by the avatar mask and the IK method may be combined, and rendering may be performed by using a blend ratio of 0 to 1, a blend model (linear interpolation or spline interpolation) that changes with time, or the like.

The content described above will be described as a procedure of steps as follows.
I. [Start]
(1) Data from motion capture
(2) Generation by logic
(3) Generation by IK
II. [Prioritization by Characteristics]

A contribution rate of −1 to +1 is set for each of the items (1), (2), and (3) described above in accordance with the avatar, the object worn by the avatar, the type selected by the user, and the like (blend parameter).
III. [Definition by Avatar Mask]×[Blend Parameter]
IV. [Animation Generation]

As a result, for example, the following actions are achieved.

A piano performance in which importance is placed on a performance based on (1), but, based on (2), the avatar may take a posture with which the score cannot be played.

A piano performance in which the avatar plays a piece of music according to the score based on (2), without performing an action of shaking the head according to the piece of music based on (1).

Soccer ball juggling in which the avatar always follows the ball of (3), but sometimes looks around based on (1).

In the foregoing description, the term “characteristics” can be regarded as a “switching algorithm for automation of operational expressions with detailed motions among behaviors of the avatar”. Which of generation by logic, generation by calculation, and data by motion capture has priority is selected to provide various expressions. Even without explicit selection, learning or calibration can be performed depending on whether the movement of motion capture is large or small or whether the movement is close to or far from the calculated movement, which can lead to diversification of individual avatar expressions.

The parameters related to the articulated model (such as the degrees of freedom of the joints) may be different for each avatar. The length, thickness, and the like of the plurality of movable body parts may also be different for each avatar.

The predetermined body part is a body part related to a predetermined skill, and may be a body part whose movement is most complicated in an action based on the predetermined skill. For example, when the predetermined skill is soccer ball juggling illustrated in FIG. 4, the predetermined body part may be a body part (a foot or head) with which the soccer ball is played. With this configuration, a body part irrelevant to the movement of the predetermined body part among the body parts other than the predetermined body part can be rendered based on a user operation in place of rendering based on the inverse kinematics or in combination with the inverse kinematics. In this case, the characteristics of each avatar can be expressed. For example, when the predetermined skill is soccer ball juggling illustrated in FIG. 4, the movement of the hands or the like may be rendered based on a user operation. Likewise, when the predetermined skill is a piano performance illustrated in FIG. 5, the movement of the head or the like may be rendered based on a user operation. In either case, rendering based on tracking information acquired by motion capture may be implemented instead of or in combination with rendering based on a user operation.

The rendering based on a user operation on the touch panel or the like may be implemented in a manner similar to that for tracking information acquired by motion capture. For example, the input unit 24 is a touch panel. In this case, the user can swipe up, down, left, or right across the touch panel to give an instruction for the position of the head, the movement of the waist, or the like, and can provide an effect of the avatar's whole body swinging. Also in the case of the button operation, making a rhythm with the legs or the neck can provide an effect of whole body swinging.

In specifications that enable rendering of facial expressions (e.g., the movement of the eyes, the mouth, and the other parts of the face) of an avatar and their related portions (such as hair and hair ornaments), a facial expression of the avatar or the movement of its related portion during the action based on the predetermined skill may also be rendered in animation or may be rendered based on a user operation. In specifications that enable rendering of facial expressions (e.g., the movement of the eyes, the mouth, and the other parts of the face) of an avatar, a facial expression of the avatar during the action based on the predetermined skill may be rendered based on face image information of the user or tracking information acquired by motion capture (e.g., face capture). The facial expressions may be rendered by using not only the motion capture data of the user themselves but also lip-sync data generated from a voice input through a microphone, a recorded sound source, or the like, or data serving as a trigger for detecting a timing by audio signal processing. Although it is difficult for a general-purpose avatar to largely open the mouth for the purpose of controlling the appearance of the shape of mouse, for example, cartoon-like exaggerated or emphasized expressions such as the characteristic opening of the mouth or the way of clenching their fists at a specific singing timing, the red flushing of the face, sweat, and comic expressions, may be applied.

Further, the movements of the predetermined body part may be rendered in animation in a manner that can differ for each avatar so that the characteristics of each avatar can appear. For example, the posture of the predetermined body part at a certain point in time (hereinafter, referred to as a “first posture”) and the posture of the predetermined body part at the next point in time (hereinafter, referred to as a “second posture”) are defined by animation data. In this case, the movement from the first posture to the second posture may be expressed by using a function that defines the speed of the movement of the predetermined body part.

For example, FIG. 10 schematically illustrates a change of a finger from a state A (the first posture) to a state B (the second posture). In FIG. 10, an angle θ (hereinafter, also referred to as “joint angle θ”) formed by two parts of a joint of the finger (the joint is represented by a black dot) changes from a joint angle θ (the state A) larger than 0 degrees to a joint angle θ equal to 0 degrees (the state B). In this case, a function selected from a plurality of functions F101 to F104 as illustrated in FIG. 11 in accordance with the personality (such as hair color, clothes, or gender) of the avatar may be used. Further, for example, the attribute of the avatar, such as an avatar playing the piano lively in casual clothes, may be associated with the personality of the avatar, such as hair color, clothes, and gender. Further, the user may be allowed to select how to play the piano (i.e., which function to apply). The functions F101 to F104 define the change in the joint angle θ with time, with the time plotted on the horizontal axis and the joint angle θ plotted on the vertical axis. As a result, the characteristics of the user, such as delicately playing the piano and aggressively playing the piano, can be reflected on the fingering. In FIG. 11, the function F101 is a linear function, whereas the functions F102 to F104 are nonlinear functions. Such functions may be easing functions. Such functions are applied to the movements or the like of the fingers (the predetermined body part) during a piano performance, or can be applied to the movements of any other predetermined body part. In FIG. 11, the four functions F101 to F104 are presented as an example. However, more or less functions may be prepared. In FIGS. 10 and 11, furthermore, a single joint angle θ is presented. However, more joint angles may be changed based on similar functions in accordance with the degrees of freedom of movement of the respective joints.

Such musical performance expressions and dance motions include subtle differences of actions based on traditional music theory. For example, in a technique of four consecutive beats, the first beat is strong (downbeat) and the last beat is weak (upbeat). Even in a basic continuous action in the same performance or dance motion, an accent such as a downbeat/upbeat gives a great impression to a viewing person, and a certain effect is widely recognized as a scientific phenomenon. As an example, playing downbeats and upbeats with the same accent makes it possible to provide an amateurish expression, and more strongly accenting downbeats while performing a softer accenting upbeat (precursor action) makes it possible to parametrically implement an emotional expression. This achieves an effect of eliminating existing manual animation work in all avatar animations.

An action based on a predetermined skill may continue for a relatively long period of time. For example, when the predetermined skill is soccer ball juggling illustrated in FIG. 4, the action based on the predetermined skill continues for at least several seconds. Further, when the predetermined skill is a piano performance illustrated in FIG. 5, the action based on the predetermined skill basically continues until the performance of a piece of music is completed.

Accordingly, during the action based on the predetermined skill, the movement of the avatar may be rendered in a manner that can differ for each avatar so that the characteristics of each avatar can appear only for a specific period of time. In this case, the avatar may be rendered based on a user operation or may be rendered based on tracking information acquired by motion capture for a specific period of time.

FIG. 12 is a diagram illustrating an example mode of changing period attributes during an action based on a predetermined skill. An attribute M1 indicates a period during which rendering in animation is applied to a movement of the predetermined body part, and an attribute M4 indicates a period during which the movements of avatars can be rendered in a manner that can differ for each of the avatars. When the predetermined skill is soccer ball juggling illustrated in FIG. 4, the period indicated by the attribute M4 (an example of a predetermined period) may be set to a period from when the soccer ball is lifted off the ground to when the soccer ball falls to the ground if this period is long. When the predetermined skill is a piano performance illustrated in FIG. 5, the period indicated by the attribute M4 may be set to an interlude period or a pause (or rest) period. In this case, in the period indicated by the attribute M4, the avatar makes a rhythm with the legs and the neck, thereby making it possible to also provide an effect of whole body swinging. For example, the avatar makes a rhythm with the legs and the neck in accordance with a user operation or motion capture information, thereby making the whole body swing, or the personality of each avatar can be exerted.

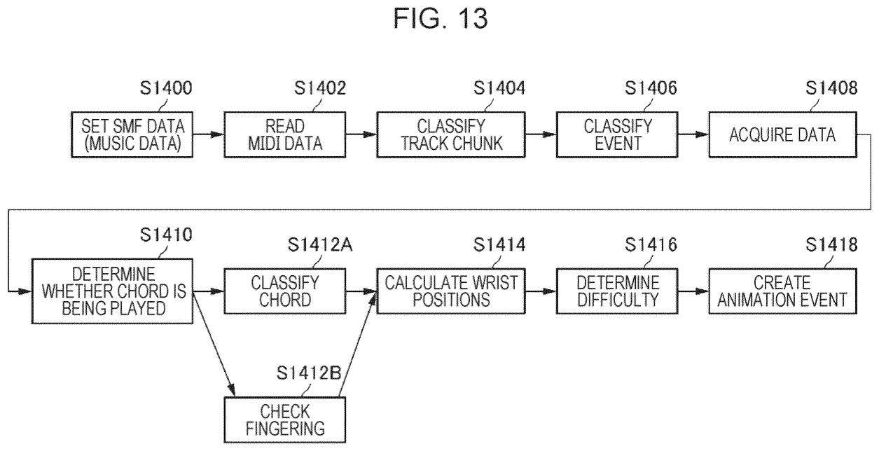

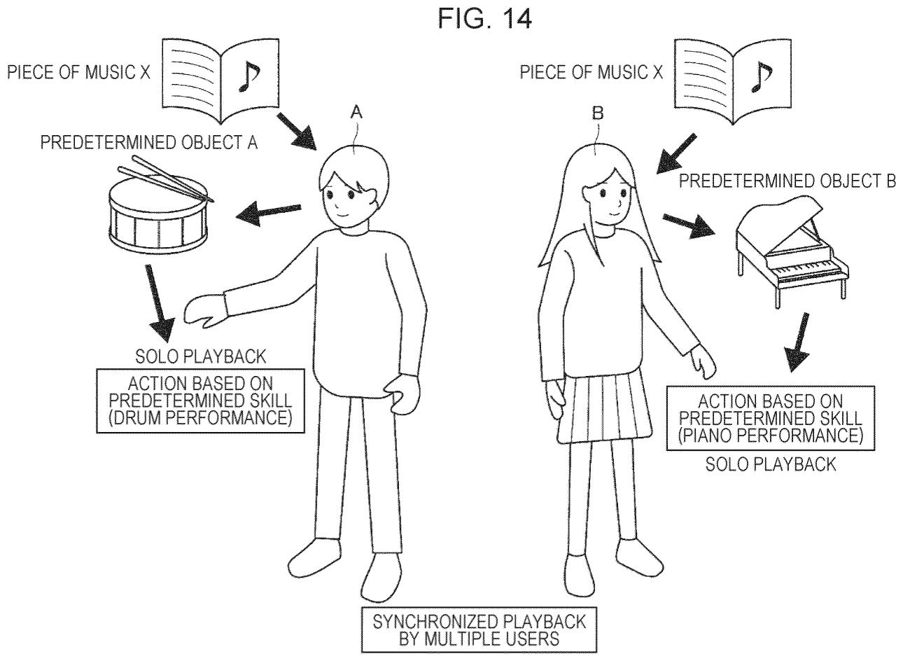

FIG. 13 is a schematic flowchart illustrating an example of a process for a specific rendering method when the predetermined skill is a performance of a musical instrument. FIG. 14 is a view illustrating synchronized playback by a plurality of avatars.

In the example illustrated in FIG. 13, standard musical instrument digital interface (MIDI) file (SMF) data to be played is set (step S1400). The SMF data includes various kinds of information such as a channel, an event (a key down or key release action), time, a pitch, and strength. Then, the MIDI data is read (step S1402). In the reading of the MIDI data, the MIDI data may be converted into easy-to-handle data. Then, a track chunk classifying process is executed (step S1404). For example, the type of a musical instrument to be played and the type of a hand (the right hand, the left hand, or both hands) to be used for playing are identified. For real-time processing, the MIDI data may contain one track chunk (that is, the MIDI data may be converted into format 0 data).

Then, an event classifying process (step S1406) is executed, and it is determined whether sounding has started or ended. Then, a data acquisition process (step S1408) is executed to acquire a pitch and a velocity. Then, it is determined whether a chord is being played (step S1410). If a chord is being played, a chord classifying process (step S1412A) is executed. If a chord is not being played, a fingering check process (step S1412B) is executed. The chord classifying process is a process of classifying various chords such as the Am chord, the G chord, and the D7 chord. The fingering check process may use fingering data that may be used for separate purposes, or may be implemented by an estimation process. Alternatively, classification may be performed by a unit based on music theory, such as one bar or four beats, and processing may be performed with a classifier. Likewise, processing may be performed by using machine learning to group similar processing units or estimating subspecies to generate a classifier that implements various musical performances with minimized motion serving as a base. Then, a wrist position calculation process (step S1414) is executed. For example, the articulated model described above may be used to calculate the positions of the wrists (see the joints A6 and A9 illustrated in FIG. 9A) based on the size of the musical instrument or the pitch. At this time, the distances to the wrists (the rotation angles around the wrists) and the speed of the music being played (beats per minute (BPM)) may be taken into account. If the length of the arms is not sufficient, the position of the upper body (including the arms) may be shifted accordingly in accordance with the inverse kinematics described above.

Then, a difficulty determination process (step S1416) is executed. The difficulty determination process may be performed based on the period of time until the next sound is played, which is calculated from the distance from the preceding sound (movement distance) and the BPM. For example, in the case of a piano, the difficulty determination process may be performed based on the period of time and distance from the key release action to the next key down action. In this case, the difficulty determination process may be executed in such a manner that the level of difficulty increases as the movement distance increases and the time decreases. Further, in the case of a musical instrument such as a piano or a percussion instrument in which the magnitude and/or accent of an action (e.g., keystroke, beat, hit, etc.) at the “key down” time, the moment of striking, and a swing-out action are important, a special motion and a special playback speed may be set for the action and the swing-out action in accordance with the period of time until the next sound is played, which is calculated from the BPM, and the personality of the avatar. The result of the difficulty determination process may be used for automatic generation of an expression performance or the like. For example, difficult fingering may be implemented with an expression performance such as a frowning facial expression. Further, the facial expression of the avatar may be changed according to the melody. For example, the avatar may smile when a piece of lively, rhythmic music is playing, and may close the eyes when a piece of slow music is playing. Then, an animation event creation process (step S1418) is executed. In the animation event creation process, the movements of the wrists and the movements of the fingers are rendered in animation.

The process illustrated in FIG. 13 does not involve tracking of all of the movements of the user, and thus the processing load can be reduced. A movement (motion) of the avatar in which the personality of the user is reflected can efficiently be rendered (played back). In the process illustrated in FIG. 13, not all of the steps are necessarily executed, and some steps may be omitted in accordance with the animation process to be performed.

The process illustrated in FIG. 13 can be applied to a plurality of musical instruments. For example, in an application to a guitar, the process may include processing for determining whether a tablature or a chord chart to use. In the use of a tablature, the same pitch may be assumed as the same fingering. However, another note may be played at the same pitch, and the distance of the next note may be calculated to determine which way to move the positions of the fingers. While the fingers of the right hand may repeat the same movement, rest information may be read to stop the movement or press the strings. A rest in the guitar may be clearly muted, and is difficult to visually recognize in a video. However, the mute action is played back as the movement of the fingers. In contrast, although an open string (in the case of a long sound) is difficult to visually recognize in the video, the string expresses the sound of the guitar being played. In the case of open strings, fingers and arms not in use can be expressed by using data from motion capture, and vibrating strings can be expressed by using video effects such as particles and blinking, signals to vibrating devices, and the like. When the avatar is playing the guitar, the movements of the arms of the avatar may be determined based on the inverse kinematics described above. When the avatar is playing the drum, basically, similar expressions to those for the guitar may be used. When the avatar is playing the drum, however, the movements of the arms according to irregular rhythms (such as drumming), rather than a simple 8-beat or 4-beat rhythm, may be separately adapted. In addition, this process can also be used in a learning system that enables three-dimensional subjective observation for learning ground-truth determination and correct performance actions in rhythm games and music games in a metaverse. The difference between the input of the user and the action along the score by the MIDI can be detected, stored, shared, made public, and distributed as the arrangement or personality.

Further, since the process can be applied to a plurality of musical instruments, a performance of a musical instrument can be streamed in real time. In one example, a combination of piano, drums, guitar, bass, and singing is possible. In another example, a four-handed performance on the piano is possible. In this case, an animation is generated at an animation event by using acquired standard MIDI file data to implement real-time generation of the animation for streaming. Further, the BPMs are synchronized with each other to adjust the start timings. As a result, for example, synchronized playback as schematically illustrated in FIG. 14 can be implemented. In the example illustrated in FIG. 14, a user associated with an avatar A and a user associated with an avatar B are different users, and collaborative streaming in a metaverse space is implemented. In this case, when the avatar A having a piece of music X as a predetermined skill approaches a predetermined object A (in the illustrated example, a drum), the predetermined trigger condition is satisfied. On the other hand, when the avatar B having the piece of music X as the predetermined skill approaches a predetermined object B (in this example, a piano), the predetermined trigger condition is satisfied. Thus, the avatar A implements a drum performance as the action based on the predetermined skill, and the avatar B implements a piano performance as the action based on the predetermined skill. These performances are synchronously played back in accordance with the BPM.

In synchronized playback, furthermore, a player (or user) such as a conductor can be made to control the BPM (to perform playback in accordance with the time of the player). In addition, participation-based collaboration is also possible in which, for example, when three avatars are performing with one another, an additional avatar participates in the performance of the three avatars. The timing of participation may be limited to the duration of a prelude, an interlude, or the like. Further, the performance data may be asynchronously stored in such a manner as to be superimposed on the performance data of another user stored in advance, or the performance data may be played simultaneously with the performance data of another user stored in advance by using a preset universal standard time as an accurate click sound of a metronome. This form of collaboration is applicable not only to music, but also to other activities or competitions (such as dancing competitions). In the rendering process for synchronized playback, mixing (stereophonic sound output) may be performed by the terminal device 20 by using client rendering, or synthesis may be performed by the server device 10. Alternatively, other systems for recording may be used. For example, computer vision and acoustic signal analysis from video recording files may be used. In addition, tracking information based on motion capture may be locally stored in the terminal device 20 or shared with other users through the server device 10. In this case, simultaneous real-time playback or temporally asynchronous playback (“shadow play”) based on the stored data can be performed. At this time, the respective pieces of tracking information related to users (tracking information acquired by motion capture) may be aligned by measuring the delay between the users.

Further, a combination with lip synchronization (lip-synching) enables a voice singing to the accompaniment of musical instruments. In this case, voice information from a user may be used.

In the present embodiment, as described above, the action based on the predetermined skill can be an action reflecting the characteristics of the avatar. Thus, after the action based on the predetermined skill is started, the field of view of the virtual camera for a nearby avatar may be changed. That is, the field of view of the virtual camera for the nearby avatar may automatically be changed so that the avatar performing the action based on the predetermined skill is well visible. Further, a virtual-space image including the avatar performing the action based on the predetermined skill may be additionally displayed on the display unit 23 of the terminal device 20 of the nearby avatar. For example, in addition to the originally displayed main screen, a sub-screen may be added in such a manner as to be superimposed on or adjacent to the main screen. This allows, advantageously, the nearby avatar to easily recognize a predetermined action of the avatar in the same virtual space. Further, in place of or in addition to the field of view of the virtual camera for the nearby avatar, the field of view of the avatar performing the action based on the predetermined skill may automatically be changed. Also in this case, the display unit 23 of the terminal device 20 of the avatar performing the action of the predetermined skill may additionally display a virtual-space image including a reaction of the nearby avatar.

When the field of view of the avatar performing the action based on the predetermined skill is automatically changed, the field of view of the avatar performing the action based on the predetermined skill may automatically be changed so that the predetermined action (e.g., the automatic reaction described above) of the nearby avatar is also well visible. A specific action of avatars (such as jumping simultaneously or playing back-to-back), or a camera motion for effectively showing the effects of the stage, such as the psyllium penlights that the audience is waving, fireworks, smoke effects, or flashlights, may be played back depending on the climax of the music or the reactions of the viewers, which are detected and set in advance. When only the field of view of a virtual camera for a nearby avatar performing an action is changed (e.g., when the field of view of the avatar performing the action based on the predetermined skill is not changed), the user (the user associated with the avatar performing the action based on the predetermined skill) can be prevented from feeling sick due to the automatic change in the field of view. In addition, each user can perform a process of causing a specific avatar to direct its gaze only toward the user. For example, the skill of “throwing a kiss to users who have purchased expensive gifts” is not directed toward specific users, but may be rendered at an angle such that all the users who have purchased gifts of specific amounts of money “individually feel that the kiss is directed toward them”. An application can be made not only to a piece of music but also to greeting, shaking hands, the gaze, and a camera for staging (or a point of view of a user wearing a head-mounted display (HMD)).

For example, the field of view of an avatar playing the piano as an action based on a predetermined skill may be changed so that the state of a nearby avatar performing an automatic reaction (such as a nearby avatar clapping hands) is visible. However, the field of view of the nearby avatar performing the automatic reaction is not particularly changed. In this case, the field of view of the nearby avatar is set as desired. Further, in the field of view of the avatar playing the piano, the state of the nearby avatar performing the automatic reaction is displayed. The actual user corresponding to the nearby avatar performing the automatic reaction freely moves. In the user's world (in the real world), the user may perform any movement. For example, the user may perform no action or may look at an object other than the avatar playing the piano. The gaze of the nearby avatar may be frequently directed toward the avatar playing the piano to express the friendship between the users.

Alternatively, when an action based on a predetermined skill is started, guidance information for viewing an avatar performing the action based on the predetermined skill may be generated for a nearby avatar. The change of the field of view of the virtual camera for the nearby avatar and the guidance information for the nearby avatar are effective in metaverse spaces. The guidance information may be given by text or voice, or information indicating the direction of the avatar performing the action may be displayed. The guidance information serves as a hint for, for example, the user in the metaverse space to determine what to do and where to go. The guidance information also serves as a trigger to communicate with another avatar. In the non-metaverse space for streaming, the field of view of the virtual camera is set based on the streaming avatar. Thus, when the streaming avatar performs the action based on the predetermined skill, the viewing user can view the streaming avatar performing the action based on the predetermined skill.

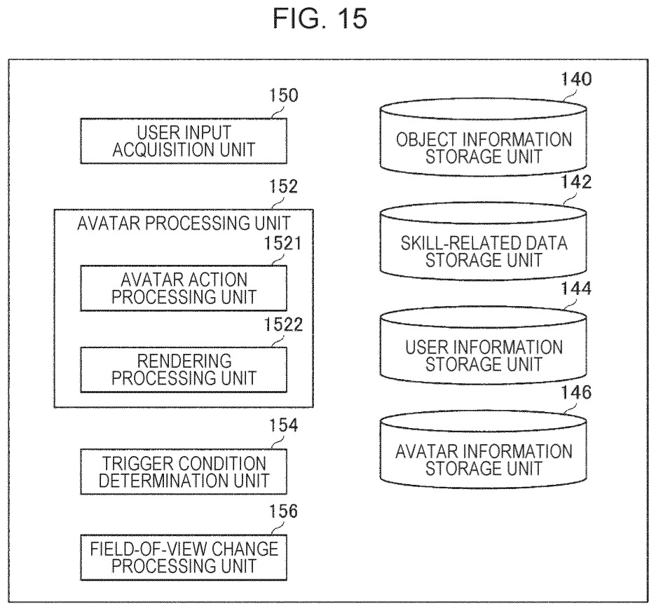

Next, an example functional configuration of the server device 10 and the terminal device 20 related to the action of the avatar based on the predetermined skill described above will be described with reference to FIG. 15 and the subsequent drawings.

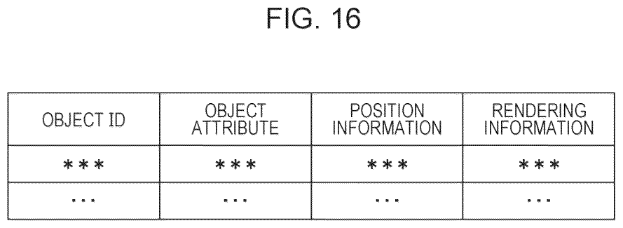

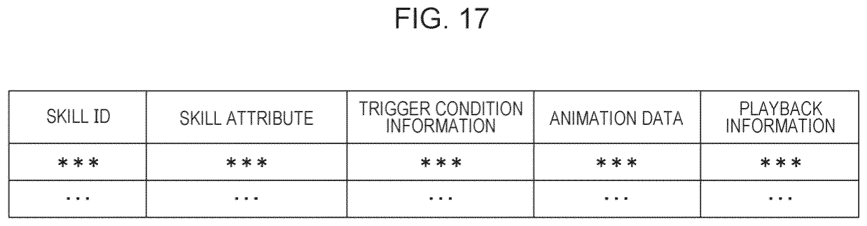

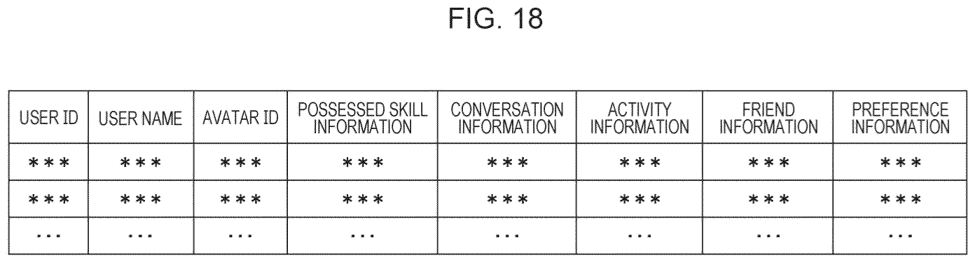

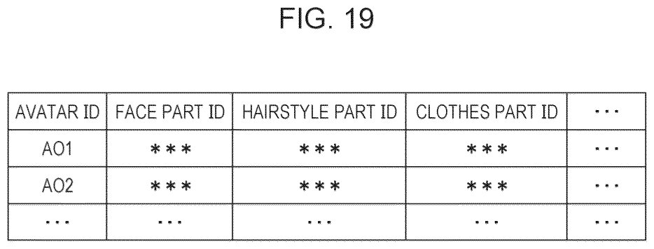

FIG. 15 is a schematic block diagram illustrating the functions of the server device 10 related to the action of the avatar based on the predetermined skill described above. FIG. 16 is a diagram illustrating an example of data in an object information storage unit 140. FIG. 17 is a diagram illustrating an example of data in a skill-related data storage unit 142. FIG. 18 is a diagram illustrating an example of data in a user information storage unit 144. FIG. 19 is a diagram illustrating an example of data in an avatar information storage unit 146. In FIG. 16, the sign “***” indicates that some information is stored, and the sign “. . . ” indicates that similar information is stored. The same applies to FIG. 17 and the subsequent drawings described below.

As illustrated in FIG. 15, the server device 10 includes the object information storage unit 140, the skill-related data storage unit 142 (an example of first to third storage units), the user information storage unit 144 (an example of a fourth storage unit), the avatar information storage unit 146, a user input acquisition unit 150 (an example of an input acquisition unit), an avatar processing unit 152, a trigger condition determination unit 154 (an example of a determination unit), and a field-of-view change processing unit 156.

In FIG. 15, the object information storage unit 140, the skill-related data storage unit 142, the user information storage unit 144, and the avatar information storage unit 146 are implementable by the server storage unit 12 of the server device 10 illustrated in FIG. 1. The functions of the user input acquisition unit 150, the avatar processing unit 152, the trigger condition determination unit 154, and the field-of-view change processing unit 156 are implementable by the server control unit 13 and the server communication unit 11 of the server device 10 illustrated in FIG. 1.

The object information storage unit 140 stores object information related to objects (including the predetermined object described above) placed in the virtual space. For example, as illustrated in FIG. 16, the object information may include, for each object ID, an object attribute, position information, and rendering information. The object ID is an ID that is automatically generated when each object is generated. The object attribute represents an attribute of each object. The position information is position information (position information in the virtual space) of each object. The position information of an object whose object attribute is a moving object may be updated as appropriate. The rendering information may include information to be used for rendering each object.

The skill-related data storage unit 142 stores skill-related data related to each of the predetermined skills described above. For example, as illustrated in FIG. 17, the skill-related data may include, for each skill ID, a skill attribute, trigger condition information, animation data (an example of predetermined data for rendering an action), and playback information.

The skill ID is an ID that is automatically generated when each predetermined skill is generated. The skill attribute represents an attribute of each predetermined skill. The attribute of each predetermined skill may include, for example, information indicating whether the predetermined skill is for collaboration. The trigger condition information may include information indicating the predetermined trigger condition described above.

The animation data includes animation data for rendering the action based on the predetermined skill described above. In rendering in animation, a moving image may be generated in advance and played back. In addition, animation data may include motion data (data indicating how to move each body part) of an avatar or an object to be used for rendering the animation, and the avatar or the object may be rendered based on the motion data of the avatar or the object. As described above, the animation data may be data related to only the movements of a predetermined body part of the avatar. In this case, the animation data can be generated such that the animation data can be shared among a plurality of avatars, resulting in data efficiency. For example, the animation data may be generated based on the model as described above with reference to FIG. 9A or 9B, which can be shared among a plurality of avatars. The animation data may be generated based on tracking information obtained when an actual person (user) has performed an actual action related to a predetermined skill. The rendering in animation is not limited to IK rendering.

The playback information includes basic information indicating a playback start condition and a playback termination condition of the animation data. When a specific period such as the period indicated by the attribute M4 described above with reference to FIG. 12 is set, the playback information may include information indicating the duration, the start timing, and the like of the specific period. The playback information may include information for synchronized playback. Further, the playback information, which represents the personality of the user, may further include personality information for reflecting the personality of the user in the action based on the predetermined skill.

The user information storage unit 144 stores information related to each user. The information related to each user also stores object information owned by the user. The information related to each user may be generated when the user is registered, for example, and may be appropriately updated thereafter. For example, in the example illustrated in FIG. 18, in the user information storage unit 144, each user ID is associated with items, namely, a user name, an avatar ID, possessed skill information, conversation information, activity information, friend information, and preference information.

The user ID is an ID that is automatically generated when each user is registered.

The user name is a name registered by each user, and is selected as desired.

The avatar ID is an ID representing an avatar used by each user. A plurality of avatar IDs may be stored for one user. The avatar ID may be associated with avatar rendering information (see FIG. 19) for rendering the corresponding avatar. The avatar rendering information associated with one avatar ID may be modified such that information is added or edited in response to, for example, an input from the corresponding user.

The possessed skill information represents one or more predetermined skills associated with the corresponding avatar. The possessed skill information may be updated when the avatar acquires a new predetermined skill or when the avatar loses a predetermined skill.

The conversation information represents information related to the content of an utterance made by the corresponding avatar in the virtual space. The conversation information may be text data. The conversation information may further include information (such as a locale ID) indicating a language to be spoken. The conversation information may also include information related to how to express the first-person pronoun, wording, a dialect, and so on.

The activity information includes information representing the history of various activities in the virtual space. The various activities may include information representing not only special activities such as participation in events and organization of events but also normal activities such as access to the virtual space and the amount of time spent in the virtual space. The activity information may be used to determine whether the acquisition condition of the predetermined skill (that is, the predetermined acquisition condition) is satisfied.

The friend information may be information (such as a user ID) that can identify users who are friends. The friend information may include information indicating the presence or absence or the degree of interaction or friendship between users. The friend information may be information on followee, follower, and mutual followers (meaning that the users follow each other).

The preference information represents the likings of the corresponding user. The preference information may include, as desired, a language setting preferred by the user or a keyword preferred by the user. Further, the user may be allowed to set likes, dislikes, and so on in advance. In this case, the preference information may include corresponding settings. The preference information may also include user profile information. The preference information may be selected through a user interface generated on the terminal device 20 and may be provided to the server device 10 by using a JavaScript Object Notation (JSON) request or the like. Further, the preference information may automatically be extracted based on the conversation information, the history of behaviors, or the like. The data in the user information storage unit 144 may be used to reflect the personality of the user in an action based on a predetermined skill as described above. For example, the conversation information, which represents the personality of the user, may be used as personality information for reflecting the personality of the user in an action based on a predetermined skill. The same applies to the preference information and the like. As described above, the personality information may be used to, for example, prepare a plurality of pieces of animation data corresponding to the personality information, or, as illustrated in FIG. 11, may be used to prepare a plurality of functions corresponding to the personality information.

The avatar information storage unit 146 stores avatar rendering information for rendering an avatar of each user. In the example illustrated in FIG. 19, in the avatar rendering information, each avatar ID is associated with a face part ID, a hairstyle part ID, a clothes part ID, and other information. Part information related to the appearance of each avatar, such as the face part ID, the hairstyle part ID, and the clothes part ID, is parameters characterizing the avatar, and may be selected by a corresponding user. All or part of the avatar rendering information is stored in association with the user ID, and a portion thereof can be selected and associated with the corresponding avatar. At this time, the object information associated with the user ID is also associated with (attached to) the corresponding avatar. For example, a plurality of types of information related to the appearance of each avatar, such as a face part ID, a hairstyle part ID, and a clothes part ID, are prepared. The face part ID may include part

IDs for the respective types of the face, such as the shape of the face, the eyes, the mouth, and the nose, and information related to the face part ID may be managed by a combination of the IDs of the respective parts of the face. In this case, each avatar can be rendered not only by the server device 10 but also by the terminal device 20 on the basis of the respective IDs related to the appearance associated with each avatar ID.

The data in the avatar information storage unit 146 may be used to reflect the personality of the user in an action based on a predetermined skill as described above. For example, the clothes, the hair style, and the like of the avatar, which represents the personality of the user, may be used as personality information for reflecting the personality of the user in an action based on a predetermined skill. As described above, the personality information such as the clothes of the avatar may be associated with the attribute of the avatar such as the way of playing the piano. The personality information may also be used to prepare a plurality of pieces of animation data or a plurality of functions.

The avatar information storage unit 146 may further store, for each avatar, various parameters (such as the position and the movable range of each joint) related to the articulated model.

The user input acquisition unit 150 acquires various user inputs, which are made by each user through the input unit 24 of the terminal device 20. The various inputs are as described above, and may include tracking information acquired by motion capture.

If the predetermined trigger condition is satisfied, the avatar processing unit 152 causes the avatar to perform the action based on the predetermined skill.

The avatar processing unit 152 includes an avatar action processing unit 1521 and a rendering processing unit 1522.

The avatar action processing unit 1521 determines, for each avatar, actions (such as a change in position and a movement of each body part) of the avatar in response to various inputs from each corresponding user.

The rendering processing unit 1522 generates an image of the virtual space including the avatar. The image is used for viewing on the terminal device 20 (terminal image). The rendering processing unit 1522 generates an image for each avatar (an image for the terminal device 20) based on the virtual camera associated with the corresponding avatar. In the present embodiment, the rendering processing unit 1522 renders an avatar performing an action based on a predetermined skill, or an avatar and a predetermined object. In this case, the rendering processing unit 1522 can render the action based on the predetermined skill with a reduced processing load, based on the skill-related data in the skill-related data storage unit 142 illustrated in FIG. 17.

If a predetermined skill is associated with one avatar, the trigger condition determination unit 154 determines whether a predetermined trigger condition is satisfied. The predetermined trigger condition is as described above. The trigger condition determination unit 154 may determine whether the predetermined trigger condition is satisfied, based on the trigger condition information in the skill-related data in the skill-related data storage unit 142 illustrated in FIG. 17.

When a single avatar performs an action based on a predetermined skill, the field-of-view change processing unit 156 automatically changes, based on the position information of the avatar, the field of view of another avatar (i.e., a nearby avatar) located around the avatar. Specifically, the field-of-view change processing unit 156 changes each of the values of the imaging parameters of the virtual camera associated with the nearby avatar so that the avatar is located in the field of view of the nearby avatar. This makes it easy for the nearby avatar to notice the avatar performing the action based on the predetermined skill, as described above, and can promote the interaction between the avatar and the nearby avatar. At this time, the field-of-view change processing unit 156 may change the gaze of the avatar performing the action based on the predetermined skill to the position information of the nearby avatar performing the reaction. Specifically, the field-of-view change processing unit 156 changes each of the values of the imaging parameters of the virtual camera associated with the avatar performing the action based on the predetermined skill so that the nearby avatar is located in the field of view of the avatar.

As described above, when one or more nearby avatars react (such as clapping or waving hands) to the action based on the predetermined skill performed by a single avatar, the field-of-view change processing unit 156 may change the field of view of the avatar performing the action based on the predetermined skill. That is, the field-of-view change processing unit 156 may change the field of view of the avatar performing the action based on the predetermined skill such that the one or more nearby avatars performing the reaction are located in the field of view of the avatar performing the action based on the predetermined skill. When the reaction is the automatic reaction described above, the field of view of the one or more nearby avatars performing the automatic reaction need not be changed. This can prevent a user associated with a nearby avatar from feeling sick (in particular, feeling “sick” while wearing a head-mounted display) due to the automatic change in the field of view. For example, a nearby avatar B is having a conversation with a different nearby avatar C without looking at an avatar A who is performing the action based on the predetermined skill. In this case, the nearby avatar B is performing an automatic reaction when viewed from the avatar A. However, the nearby avatar B itself is still having a conversation with the nearby avatar C. In this case, the action of the nearby avatar B in the terminal image of the user of the avatar A is different from the action of the nearby avatar B in the terminal image of the user of the nearby avatar B.

As described above, when one or more nearby avatars react (such as clapping or waving hands) to the action based on the predetermined skill performed by a single avatar, the field-of-view change processing unit 156 may change the field of view of another avatar (further nearby avatar) located around the one or more nearby avatars performing the reaction. That is, the field-of-view change processing unit 156 may change the field of view of the further nearby avatar such that the one or more nearby avatars performing the reaction is located in the field of view of the further nearby avatar. In this case, the further nearby avatar may be one of the nearby avatars located nearby the avatar performing the action based on the predetermined skill, or may include a different avatar.

The manner described above in which the functions are shared between the server device 10 and the terminal device 20 is merely an example, and has been described in the context of server rendering. As described above, various changes can be made. That is, some or all of the functions of the server device 10 may be implemented by the terminal device 20 as appropriate. In server rendering, a moving image rendered by the server control unit 13 (the avatar processing unit 152) of the server device 10 is transmitted to the terminal device 20, and the display unit 23 of the terminal device 20 displays the moving image. That is, operation information is collected from the terminal device 20, and a video is generated by the server device 10 and is broadcast to each terminal device 20 (video is generated from the beginning). Alternatively, client rendering or browser rendering may be used. Client rendering and browser rendering are as follows.

First, in client rendering, the terminal device 20 receives an image of an avatar, an object, or the like and a rendering program from the server device 10 and holds the image and the rendering program in advance. The terminal device 20 receives identification information, motion data, and voice data of the avatar from the server device 10. The terminal device 20 calls an image of the avatar or the like, which is already held, in accordance with the received identification information and motion data, and renders a moving image, that is, generates and displays a moving image.

In browser rendering, first, an HTML document is downloaded, and data to be used, such as an image and a program (JavaScript) that operates on the browser, is downloaded to the server device 20 described in the HTML document. Then, data for processing of each terminal is received from the server device 10, and rendering is performed by using the program (JavaScript) on the browser. Browser rendering is similar to client rendering using an application, except that the HTML language is used, and the difference therebetween is that image data of an avatar or the like once downloaded can be left in the application, whereas the browser is stored in a random access memory (RAM) and no data is left on the terminal device 20 after the browser is closed. On the browser that remembers uniform resource locators (URLs) by using a cookie, an image or the like of an avatar needs to be downloaded at each time. The HTML document describes where to download the avatar, that is, from which server to download the avatar.

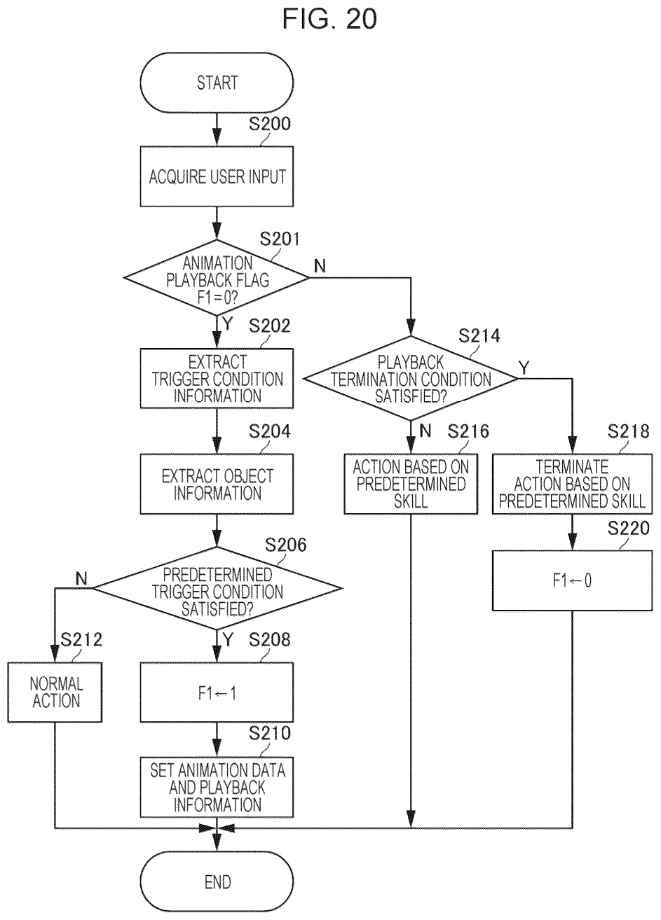

Next, an example of the operation of the virtual reality generation system 1 related to the action of the avatar based on the predetermined skill described above will be described with reference to FIG. 20 and the subsequent drawings.

FIG. 20 is a flowchart schematically illustrating an example of the operation of the virtual reality generation system 1 related to the action of the avatar based on the predetermined skill described above.

FIG. 20 is a schematic flowchart illustrating an example of a process executed by the server device 10 in relation to the action of the avatar based on the predetermined skill described above. The process illustrated in FIG. 20 is a process related to a specific avatar (hereinafter, also referred to as a “target avatar”). The process may be repeatedly performed at predetermined intervals. The process illustrated in FIG. 20 may be performed in parallel for different avatars in the virtual space. The following description is based on the assumption that one or more predetermined skills are associated with the target avatar.

In step S200, the server device 10 acquires a user input in the current iteration from the user corresponding to the target avatar.

In step S201, the server device 10 determines whether an animation playback flag F1 is “0”. When the animation playback flag F1 is “1”, this indicates that animation data is being played back in relation to the action of the avatar based on the predetermined skill described above. When the animation playback flag F1 is “0”, this indicates other states. If the determination result is “YES”, the process proceeds to step S202. Otherwise, the process proceeds to step S214.

In step S202, the server device 10 extracts trigger condition information related to the one or more predetermined skills associated with the target avatar.

In step S204, the server device 10 extracts object information related to each object arranged near the target avatar. In this case, the object for which the object information is to be extracted may be only the object related to the trigger condition information extracted in step S202.

In step S206, the server device 10 determines, based on the trigger condition information obtained in step S202 and the object information obtained in step S204, whether a predetermined trigger condition related to the one or more predetermined skills associated with the target avatar is satisfied. If the determination result is “YES”, the process proceeds to step S208. Otherwise, the process proceeds to step S212.

In step S208, the server device 10 sets the animation playback flag F1 to “1”.

In step S210, the server device 10 sets animation data and playback information (see FIG. 17) related to a predetermined skill (hereinafter also referred to as a “target predetermined skill”) for which the predetermined trigger condition is satisfied.

In step S212, the server device 10 causes the target avatar to perform a normal action (such as running, walking, or flying) in response to various inputs from the user. If no user input is acquired (i.e., if the user does not perform any input), the target avatar may be maintained in a predetermined stationary state.

In step S214, the server device 10 determines whether a condition for terminating the playback of the animation data is satisfied during the playback of the animation data. The condition for terminating the playback may be satisfied at the end of the animation data, or may be satisfied in response to a predetermined user input (termination instruction) or the like before the end of the animation data. If the determination result is “NO”, the process proceeds to step S216. Otherwise, the process proceeds to step S218.

In step S216, the server device 10 causes the target avatar to perform an action based on the target predetermined skill.

In step S218, the server device 10 terminates the action based on the target predetermined skill, which has been executed in step S216 in the previous processing iteration.

In step S220, the server device 10 resets the animation playback flag F1 to “0”.

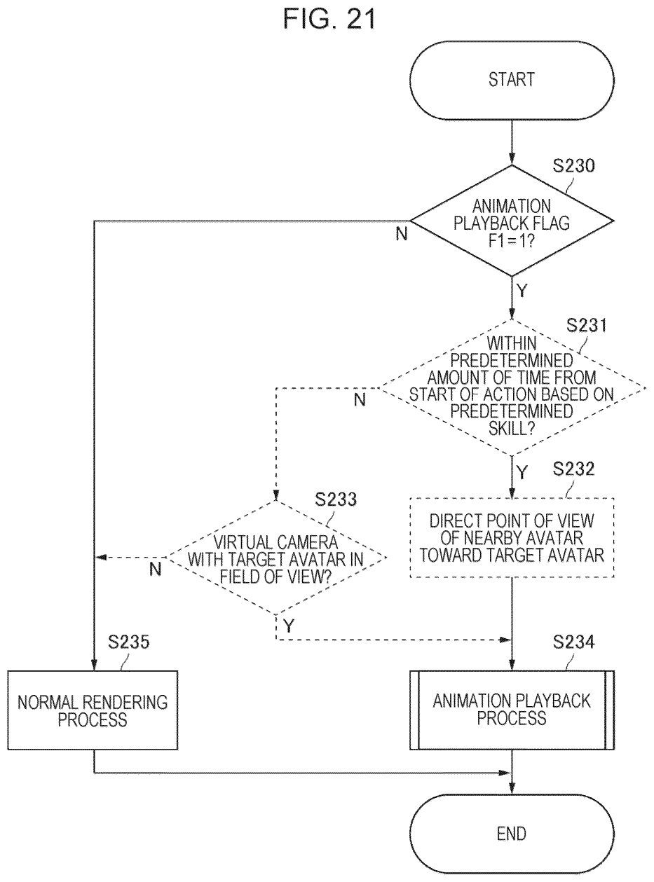

FIG. 21 is a schematic flowchart illustrating an example rendering process related to the target avatar, which is executed in relation to the process illustrated in FIG. 20.

In step S230, the server device 10 determines whether the animation playback flag F1 is “1”. If the determination result is “YES”, the process proceeds to step S231. Otherwise, the process proceeds to step S235.

In step S231, the server device 10 determines whether the current time is within a predetermined amount of time immediately after the animation playback flag F1 is set to “1”. That is, the server device 10 determines whether the elapsed time from the start of the action based on the target predetermined skill is within the predetermined amount of time. In the server device 10, the predetermined amount of time is an amount of time for making a nearby avatar aware of the action based on the target predetermined skill. The predetermined amount of time may be a fixed value or a variable value. If the determination result is “YES”, the process proceeds to step S232. Otherwise, the process proceeds to step S233.

In step S232, the server device 10 forcibly (and temporarily) directs the gaze of the nearby avatar toward the target avatar. That is, the gaze of the virtual camera is changed so that the target avatar is included in the field of view of the virtual camera for the user associated with the nearby avatar. The nearby avatar may include an avatar within a predetermined distance from the target avatar. The gaze of the nearby avatar may be directed toward the target avatar temporarily (e.g., for the predetermined amount of time obtained in step S231). The server device 10 need not change the gazes of all nearby avatars. The server device 10 may change only the gaze of a nearby avatar that is highly likely to be interested in the action based on the target predetermined skill. In this case, the processing load can be efficiently reduced as compared with that when the gazes of all nearby avatars are changed. Whether each nearby avatar is interested in the action based on the predetermined skill may be determined based on user information (e.g., preference information) of the nearby avatar. For example, when the action based on the predetermined skill is soccer ball juggling, a nearby avatar that likes soccer may be extracted based on the preference information, and only the gaze of the extracted nearby avatar may be changed.

In step S233, the server device 10 determines whether the virtual cameras for the users associated with nearby avatars include a virtual camera whose field of view includes the target avatar. That is, the server device 10 determines whether any nearby avatar is viewing the target avatar. If the determination result is “YES”, the process proceeds to step S234. Otherwise, the process proceeds to step S235.

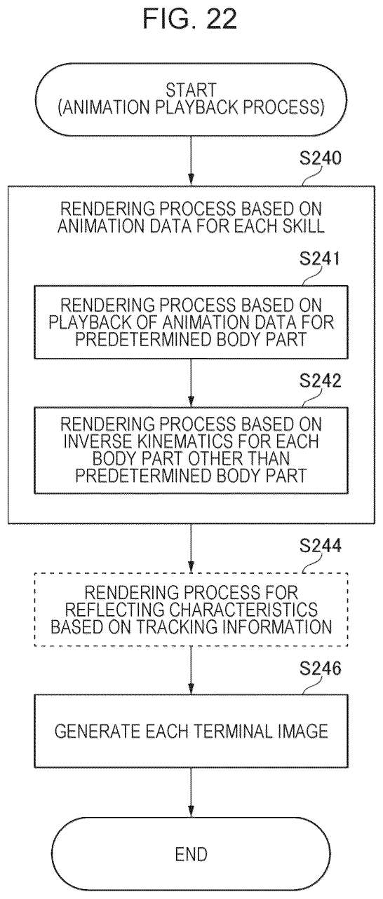

In step S234, the server device 10 executes a process of playing back the animation data for the target avatar (hereinafter, also referred to simply as an “animation playback process”), based on the animation data and the playback information set in step S210 (see FIG. 20). A specific example of the animation playback process will be described below with reference to FIG. 22. In the present embodiment, in step S234, the target avatar or the target avatar and the predetermined object are rendered.

In step S235, the server device 10 executes a normal rendering process. At this time, when the animation playback flag F1 is “0”, the target avatar during the normal action related to step S212 (see FIG. 20) is rendered if the target avatar is present in the field of view of the virtual camera for the user associated with the nearby avatar.

In the process illustrated in FIG. 21, some of the rendering processes related to the target avatar may be changed. For example, step S231 and step S233 may be omitted to direct the point of view of the nearby avatar toward the target avatar regardless of the predetermined amount of time from the start of the action based on the predetermined skill. In this case, in the flowchart illustrated in FIG. 21, the processing of step S230, the processing of step S232, and the processing of step S234 are performed in this order. Alternatively, regardless of whether to omit step S231 and step S233, the processing of step S232 and the processing of step S234 may be performed simultaneously or in parallel. If the point of view of the nearby avatar is not to be directed toward the target avatar, step S232 may also be omitted in addition to step S231 and step S233.

FIG. 22 is a schematic flowchart illustrating an example of the animation playback process (step S234 in FIG. 21).

In step S240, the server device 10 performs a process of rendering an avatar based on animation data of each skill.

As described above, several methods are available for the rendering process. If the inverse kinematics is used in step S240, first, in step S241, the server device 10 performs the rendering process based on playback of the animation data for the predetermined body part described above among the body parts of the target avatar. Then, in step S242, the server device 10 performs a rendering process on each of the body parts other than the predetermined body part among the body parts of the target avatar in accordance with the inverse kinematics based on the position and orientation of the predetermined body part.

In step S244, the server device 10 performs a rendering process for reflecting characteristics of the other body parts (e.g., facial expression) of the target avatar in accordance with tracking information acquired by motion capture among the user inputs for the target avatar. In the rendering process, rendering may be performed by using tracking information acquired by motion capture in accordance with the periods of time described with reference to FIG. 12 in addition to the body parts. If the characteristics are not reflected, step S244 may be omitted.

In step S246, the server device 10 generates terminal images (images for viewing on the terminal devices 20) corresponding to the gazes from the respective virtual cameras by using the results of the rendering processes in steps S240 to S244.

The features of the embodiments described above and the differences from the motions developed in the related art are summarized as follows.

Elements that react to the environment and the relationship with another user (friend) are included.

Elements whose reaction in an asymmetric relationship such as the relationship between a streamer and a viewer changes depending on a degree of support from the viewer are included.

Elements that are widely available from MIDI files, audio signal processing, and video recordings, even for general-purpose music, are included.

The handling of a moving image including a recorded performance (music copyright processing or backup or reuse of motion data differences) is likely to be clarified based on elements converted to user-generated content (UGC) by the personality of the user themselves.

The created UGC is resold, and an incentive is earned for viewing the UGC when the UGC becomes popular.

The transfer of a skill object (more specifically, collaboration as a virtual trainer) can enhance communication with a user with a specific popular skill.

Also, the deprivation of skills in a battle game, the duplication of skills in a cooperative game, and so on are implemented, leading to high compatibility with the existing games.

While some embodiments have been described in detail, the present disclosure is not limited to specific embodiments and may be modified or changed in various ways without departing from the scope as set forth in the appended claims. Further, all or some of the elements of the embodiments described above may be combined.

For example, in the embodiments described above, three elements, namely, a predetermined skill, a predetermined trigger condition, and a predetermined object, have a relationship with one another such that the predetermined trigger condition is associated with the predetermined skill and the predetermined trigger condition is related to the predetermined object. Equivalently, it can be said that the predetermined object is associated with the predetermined skill with a common predetermined trigger condition interposed therebetween. That is, it can be said that the predetermined object is associated with the predetermined skill and the predetermined trigger condition is related to the predetermined object. In this case, the object information storage unit 140 may store one or more skill IDs in association with each object ID. In this case, if a predetermined trigger condition related to a specific predetermined object is satisfied for an avatar with which a predetermined skill is associated, an action based on the predetermined skill associated with the specific predetermined object may be implemented. For example, in a case where various predetermined skills such as juggling, shooting, and dribbling are associated with a soccer ball (predetermined object), when an avatar associated with juggling as a predetermined skill is located within a predetermined distance from the soccer ball, a predetermined trigger condition related to the soccer ball is satisfied for the avatar. Accordingly, in this case, the avatar can perform an action based on juggling (predetermined skill). When an avatar associated with juggling and shooting as predetermined skills is located within a predetermined distance from the soccer ball, a predetermined trigger condition related to the soccer ball is satisfied for the avatar. Accordingly, in this case, the avatar can perform an action based on the predetermined skill for a selected one of juggling and shooting.

In addition to the embodiments described above, duplication and transfer of skill objects can also be implemented by collaboration. For example, the duplication, transfer, or deprivation of skill objects described above can be reasonably implemented by behaviors such as continuously observing an avatar performing soccer ball juggling from a short distance, having a conversation for a certain amount of time, playing a mini game, achieving a certain task in a cooperative play game, and winning an opponent in a battle play game. Other applications include, but are not limited to, a contest in a music event (e.g., a skill allowed only for a player who has won an air guitar contest), and a deadly skill in a fighting game.

What is claimed is:

1. An information processing system, comprising:
processing circuitry configured to:
store a skill related to an action in a virtual space;
store a trigger condition associated with the skill, the trigger condition being related to an object in the virtual space;
determine, in a case that the skill is associated with an avatar, whether the trigger condition is satisfied; and
control, in a case that the trigger condition is determined to be satisfied, the avatar to perform the action based on the skill.

2. The information processing system according to claim 1, wherein the trigger condition is related to a positional relationship between the object and the avatar.

3. The information processing system according to claim 1, wherein the trigger condition is satisfied when a positional relationship between the object and a body part of the avatar becomes a particular relationship.

4. The information processing system according to claim 1, wherein
the object includes an item wearable by the avatar, and
the trigger condition is satisfied when the avatar wears the item.

5. The information processing system according to claim 1, wherein the processing circuitry is further configured to:
store a plurality of skills including the skill; and
store a plurality of trigger conditions including the trigger condition such that one or more trigger conditions are associated with one skill of the plurality of skills.

6. The information processing system according to claim 5, wherein the processing circuitry is further configured to:
acquire a user input associated with the avatar; and
in a case that one common trigger condition associated with the plurality of skills is satisfied, control the avatar to perform an action based on one or more skills selected based on the user input from among the plurality of skills associated with the one common trigger condition.

7. The information processing system according to claim 5, wherein and
at least two of the plurality of trigger conditions are associated with one of the skills, and
the at least two trigger conditions are related to different objects.

8. The information processing system according to claim 1, wherein the processing circuitry is further configured to:
store data for rendering an action in association with the skill;
render the avatar performing the action based on the skill; and
render the object and the avatar, based on the data.

9. The information processing system according to claim 8, wherein the processing circuitry is further configured to:
acquire a user input associated with the avatar;
render a body part of the avatar, based on the data, the body part being included in movable body parts of the avatar; and
render at least one movable body part, other than the body part among the movable body parts, based on the user input.

10. The information processing system according to claim 9, wherein the processing circuitry is configured to render the body part and the object move in conjunction with each other.

11. The information processing system according to claim 10, wherein the processing circuitry is further configured to render another body part, different from the body part among the movable body parts of the avatar, to move in conjunction with a movement of the body part.

12. The information processing system according to claim 9, wherein the processing circuitry is further configured to be capable of rendering the body part based on the user input for at least a period when the action based on the skill is being performed.

13. The information processing system according to claim 8, wherein the processing circuitry is further configured to:
store personality information related to a personality of a user associated with the avatar or a personality of the avatar; and
render the avatar based on the data and the personality information of the avatar when the action based on the skill is being performed.

14. The information processing system according to claim 8, wherein the data includes animation data.

15. The information processing system according to claim 8, wherein the data includes data sharable across a plurality of avatars including the avatar.

16. The information processing system according to claim 8, wherein the processing circuitry is further configured to:
store a plurality of skills including the skill; and
store a plurality of types of data including the data in such a manner that one or more types of data are associated with one of the skills.

17. The information processing system according to claim 1, wherein the processing circuitry is further configured to, in a case that the target avatar performs the action based on the skill, change a field of view of another avatar located around the target avatar, based on position information of the target avatar.

18. The information processing system according to claim 17, wherein the processing circuitry is configured to change the field of view of the other avatar such that the target avatar is in the field of view of the other avatar.

19. The information processing system according to claim 1, wherein the processing circuitry is further configured to change a field of view of the target avatar such that another avatar located around the target avatar is in the field of view of the target avatar when the other avatar performs an action related to the action based on the skill performed by the target avatar.

20. A non-transitory computer-readable information storage medium storing computer-executable instructions that, when executed by one or more processors of an information processing system, cause the one or more processors to:
store a skill related to an action in a virtual space;
store a trigger condition associated with the skill, the trigger condition being related to an object in the virtual space;
determine, in a case that the skill is associated with an avatar, whether the trigger condition is satisfied; and
control, in a case that the trigger condition is determined to be satisfied, the avatar to perform the action based on the skill.

21. A method for processing information, executed by a computer, the method comprising:
storing a skill related to an action in a virtual space;
storing a trigger condition associated with the skill, the trigger condition being related to an object in the virtual space;
determining, in a case that the skill is associated with an avatar, whether the trigger condition is satisfied; and
controlling, in a case that the trigger condition is determined to be satisfied, the avatar to perform the action based on the skill.

22. An information processing device, comprising:
processing circuitry configured to:
store a skill related to an action in a virtual space;
store a trigger condition associated with the skill, the trigger condition being related to an object in the virtual space;
determine, in a case that the skill is associated with an avatar, whether the trigger condition is satisfied; and
control, in a case that the trigger condition is determined to be satisfied, the avatar to perform the action based on the skill.
